(19) United States
(12) Patent Application Publication
(10) Pub. No.: US 2025/0100912 A1
(43) Pub. Date: Mar. 27, 2025

(54) Salinity Exchange for Low-Cost and High-Quality Potable Water

(71) Applicant: Georgia Tech Research Corporation, Atlanta, GA (US)

(72) Inventors: Xing Xie, Atlanta, GA (US); Yongsheng Chen, Marietta, GA (US); Zeou Dou, Atlanta, GA (US); Mourin Jarin, Atlanta, GA (US)

(21) Appl. No.: 18/730,978

(22) PCT Filed: Jan. 24, 2023
(86) PCT No.: PCT/US2023/061132

§ 371 Date: Jul. 22, 2024

Related U.S. Application Data
(60) Provisional application No. 63/302,721, filed on Jan. 25, 2022.

(51) Int. Cl. C02F 1/469; B01D 61/46; C02F 103/08; H01M 8/22

(52) U.S. Cl. CPC C02F 1/4693; B01D 61/463; H01M 8/227; B01D 2313/28; B01D 2313/367; C02F 2103/08; C02F 2201/009

(57) ABSTRACT

An exemplary embodiment of the present disclosure provides a method for purifying salt water. The method comprises the steps of removing at least a portion of salt in the salt water to form a potable water and introducing the at least a portion of the salt removed from the salt water to a water feed.

### CROSS-REFERENCE TO RELATED APPLICATIONS

This application claims the benefit of U.S. Provisional Application Ser. No. 63/302,721, filed on 25 Jan. 2022, which is incorporated herein by reference in its entirety as if fully set forth below.

### FEDERALLY SPONSORED RESEARCH STATEMENT

This invention was made with government support under Agreement number R19AC00101 awarded by the Department of Interior. The government has certain rights in the invention.

### FIELD OF THE DISCLOSURE

The various embodiments of the present disclosure relate generally to systems and methods for producing desalinated potable water.

### BACKGROUND

Desalination is an important strategy to address the increasing global freshwater demand, given the fact that seawater and brackish water account for about 98% of all the water on the earth. Large-scale desalination processes can be generally categorized into thermal and membrane-based technologies. In the arid Gulf countries, desalination plants are mainly based on thermal distillation, where the seawater is heated and the evaporated water is condensed to produce freshwater. Desalinated water may retain low levels of salt concentrations consistent with potable water levels. The two most important thermal desalination processes are multiple effect distillation (MED), and multistage flash desalination (MSF) with a share of 8 and 23% of global desalination plants in operation, respectively. For both processes, the seawater is heated and evaporated stage-wise to improve the heat exchange efficiency. However, such plants still consume substantial amounts of thermal and electric energy, resulting in large emissions of greenhouse gases. In recent years, improvement in efficiency and energy consumption has been made, which makes optimized processes, like membrane distillation and humidification-dehumidification, come into existence. Solar energy has been reported to be utilized for distillation through the development of novel broadband absorbers and membranes. Except for the Gulf countries, the vast majority (64%) of desalination plants are based on reverse osmosis (RO) technology. In RO, seawater is highly pressurized against a semi-permeable membrane that allows water to flow through but retains salt. The exceeded osmosis pressure driving water through the membrane is achieved by a high-pressure feed pump. Meanwhile, differential pressure losses through the system need to be overcome. In the past two decades, RO has been improved significantly, and current RO plants can operate with much less energy than thermal desalination. This decrease in energy consumption is typically attributed to the development of higher-permeability membranes, like nanocomposite membranes, and installation of energy recovery units, and the use of more efficient pumps.

TABLE 1
Energy consumption and water cost of
commercial desalination processes ²⁷.

| | Thermal | Electrical | Total | Investment | Total |
|---|---|---|---|---|---|
| | energy | energy | energy | cost | water cost |
| Process | (kWh/m³) | (kWh/m³) | (kWh/m³) | ($/m³/d) | ($/m³) |
| MSF | 7.5-12 | 2.5-4 | 10-16 | 1200-2500 | 0.8-1.5 |
| MED | 4-7 | 1.5-2 | 5.5-9 | 900-2000 | 0.7-1.2 |
| RO | — | 3-4 | 3-4 | 900-2500 | 0.5-1.2 |

In addition to commercialized membrane-based processes, some other desalination systems based on electrochemical processes have been investigated. Electrodialysis (ED) is an electro-membrane process transferring salt ions from a dilute solution to a concentrated solution through alternating anion/cation-exchange membranes in an electrical field exerted by an external voltage applied on two end electrodes. The studies of these systems mainly focus on hybrid desalination processes, aiming to improve energy consumption. However, the dilute solutions impose significant electrical resistance causing low current efficiency, high over-potential, and split of water at the surface of the ED membrane. Capacitive deionization (CDI) is an emerging technology for water desalination based on ion electrosorption. In a classic CDI, a saline solution flows through a capacitor-like module comprising a pair of porous electrodes. An electric potential of typically 1-1.4 V is applied to the electrodes, upon which salt ions in the saline feed solution migrate into electrical double layers along the pore surfaces at the solid/liquid interface, resulting in desalination. After adsorption, the saturated electrodes are regenerated by discontinuing the external potential or reversing the polarity to discharge the salt ions. In the pursuit of electrodes of higher ion-exchange capacity and rate, the faradic battery electrode has been integrated into CDI system, which is referred to as desalination battery. Desalination battery systems adsorb and connect ions to the electrode by chemical bonds through redox reactions, rather than storing the ions in the electrical double layers at the surface. Nevertheless, energy consumption remains a major obstacle for the implementation of desalination plants.

Additionally, salinity-gradient energy results from the change of entropy when two solutions with different salinity are mixed. Theoretically, a substantial amount of energy ranging from 0.75 to 14.1 kWh per cubic meter of the low salinity solution is extractable from the mixing of typical fresh water and seawater. Globally, the total salinity-gradient energy from mixing river water with seawater is estimated to be about 2 TW—as remarkable as ˜980 GW of which could be potentially harnessed. Several approaches to capture salinity-gradient energy are being developed, among which reverse electrodialysis (RED) is one of the most promising technologies. In a typical RED cell, low-salinity and high-salinity solutions are separated by selective ion-exchange membranes. Anions and cations, driven by the concentration difference, pass through membranes creating ionic flux, which is then converted into an electric current through redox reactions at electrodes. A full-scale RED system usually comprises multiple stacks of membranes with alternating anion/cation-exchange membranes to boost the voltage output. Lowering the cost of ion-exchange membranes and reducing the spacing between membranes can be essential for the commercialization of RED. The use of ion-conductive spacers between the membranes or introducing ridges and flow patterns into the membrane material are promising for reducing the footprint of RED systems and increasing power generation. To be rendered commercially viable, advanced improvement is needed to further increase the power density produced by RED.

Further, in light of population growth, urbanization, and climate change, potable water reuse, particularly direct potable reuse (DPR), is increasingly being considered as a large “untapped” water resource to help mitigate the exponentially growing water demands. DPR refers to the introduction of purified water, reclaimed from municipal wastewater, directly into a municipal water supply system, without flowing through an environmental buffer such as a reservoir or aquifer. Based on available data in the US, water conveyance currently requires four times the energy required for treatment. Therefore, DPR offers the potential to significantly reduce the costs and energy consumption of current water supply system by reducing the distance that purified water would need to be pumped and the head against which it must be pumped, due to its compatibility with the existing water distribution infrastructure. In addition, DPR provides an opportunity for the implementation of novel advanced technologies in decentralized and diversified water treatment for a specific purpose, which can further reduce the costs. Despite all the advantages, development and implementation of DPR still faces several challenges, including the lack of general principles and guidance for process design, limited economic and performance data, lack of regulatory structure, and most critically, public acceptance.

Thus, there is a need for producing potable drinking water in an energy efficient and publicly acceptable manner. This can be achieved by controlling the parameters in desalinating water.

### BRIEF SUMMARY

The present disclosure relates to systems and methods for producing desalinated potable water. An exemplary embodiment of the present disclosure provides a method for purifying salt water. The method can include removing at least a portion of salt in the salt water to form a potable water and introducing the at least a portion of the salt removed from the salt water to a water feed.

In any of the embodiments disclosed herein, the method can comprise introducing the salt water and the water feed to at least one alternating chamber amongst a set of adjacent chambers.

In any of the embodiments disclosed herein, the adjacent chambers can be separated from each other by a set of coadjacent membranes and the set of adjacent chambers can be disposed between a pair of electrodes.

In any of the embodiments disclosed herein, the set of coadjacent membranes can comprise an alternating set of anion exchange membranes and cation exchange membranes.

In any of the embodiments disclosed herein, the salt water can comprise a plurality of cations and anions, and at least a portion of the salt in the salt water can be removed by passing the plurality of cations and the anions through the set of coadjacent membranes.

In any of the embodiments disclosed herein, a salt concentration difference between the salt water in a first chamber in the adjacent chambers and the water feed in a second chamber in the adjacent chambers adjacent to the first chamber can cause at least a portion of the plurality of cations to pass from the salt water, through a coadjacent exchange membrane in the set of coadjacent exchange membranes, and to the water feed, thereby harvesting a first salinity-gradient energy.

In any of the embodiments disclosed herein, a salt concentration difference between the salt water in a first chamber in the adjacent chambers and the water feed in a third chamber in the adjacent chambers adjacent to the first chamber can cause at least a portion of the plurality of anions to pass from the salt water, through a second coadjacent exchange membrane in the set of coadjacent exchange membranes, and to the water feed, thereby harvesting a second salinity-gradient energy.

In any of the embodiments disclosed herein, the pair of electrodes consuming at least a portion of the first salinity-gradient energy can cause at least a second portion of the plurality of cations to pass from the salt water in the first chamber in the adjacent chambers, through the first coadjacent exchange membrane in the set of coadjacent exchange membranes, and to the water feed, in the second chamber in the adjacent chambers adjacent to the first chamber.

In any of the embodiments disclosed herein, the pair of electrodes consuming at least a portion of the second salinity-gradient energy can cause at least a second portion of the plurality of anions to pass from the salt water in the first chamber in the adjacent chambers, through the second coadjacent exchange membrane in the set of coadjacent exchange membranes, and to the water feed, in the third chamber in the adjacent chambers adjacent to the first chamber.

In any of the embodiments disclosed herein, the method can consume less than 1 kWh/m³ of potable water produced.

In any of the embodiments disclosed herein, the method can consume less than 0.5 kWh/m³ of potable water produced.

In any of the embodiments disclosed herein, salt water can include a salt concentration ranging from about 0.1 M to about 0.6 M.

In any of the embodiments disclosed herein, the potable water can include a salt concentration less than 0.015 M.

In any of the embodiments disclosed herein, the water feed further can include a salt concentration ranging from about 0.01 M to about 0.03 M.

In any of the embodiments disclosed herein, the salt water further can include a salinity ranging from about 9 g/L to about 32.45 g/L.

In any of the embodiments disclosed herein, the potable water can include a salinity less than 0.9 g/L.

In any of the embodiments disclosed herein, the water feed further can include a salinity ranging from about 0.7 g/L to about 1.8 g/L.

In any of the embodiments disclosed herein, the salt water further can include a conductivity from about 10 mS/cm to about 59.27 mS/cm.

In any of the embodiments disclosed herein, the potable water can include a conductivity less than 1.917 mS/cm.

In any of the embodiments disclosed herein, the water feed further can include a conductivity ranging from about 1.278 mS/cm to about 3.834 mS/cm.

In any of the embodiments disclosed herein, the method can comprise feeding a salt water and a treated wastewater into alternating chambers of an electrodialysis cell separated by a set of ion exchange membranes, transferring through reverse electrodialysis at least a portion of salt from the salt water to the treated wastewater to approximately equalize a salt concentration in the salt water and a salt concentration in the treated wastewater, extracting a salinity-gradient energy harvested from a difference in salt concentration between the salt water and the treated wastewater, and transferring, through electrodialysis by consuming at least a portion of the salinity-gradient energy, at least a second portion of salt in the salt water to the treated wastewater, to yield a desalinated salt water and an increased-salinity treated wastewater.

In any of the embodiments disclosed herein, the method can comprise transferring at least a portion of a salt from a salt water to a wastewater through reverse electrodialysis, and extracting at least a portion of a salinity-gradient energy harvested from a difference in salt concentration between the salt water and the wastewater, transferring at least a second portion of the salt, through electrodialysis by consuming at least a portion of the extracted salinity-gradient energy, from the salt water to the wastewater, to yield a decreased salinity salt water and an increased salinity wastewater, and discharging the increased salinity wastewater directly to an environmental saltwater source.

Another exemplary embodiment of the present disclosure provides a system for desalinating salt water. The system can comprise saltwater feed streams, treated wastewater feed streams, decreased salinity saltwater outlet streams, increased salinity treated wastewater outlet streams, and electrodialysis cells. The electrodialysis cells can include adjacent chambers, ion-exchange membranes, electrodes, electrode rinse solution, and power sources.

In any of the embodiments disclosed herein, the set of adjacent chambers can alternatively connect to the saltwater feed stream and to the treated wastewater feed stream.

In any of the embodiments disclosed herein, the electron rinse solution can circulate between electrodes.

In any of the embodiments disclosed herein, the system can comprise electrodes in electrical communication with each other and a power source.

In any of the embodiments disclosed herein, the system can comprise electrodes made from conductors, semi-conductors, or Ti mesh.

In any of the embodiments disclosed herein, the electrode rinse solution can include a mixture of 0.05 M K₃Fe(CN)₆, 0.05 M K₄Fe(CN)₆·3H₂O, and 0.25 M NaCl.

In any of the embodiments disclosed herein, the increased salinity treated wastewater outlet stream can meet a discharge standard for direct ocean discharges.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1A provides a schematic of a method for salinity exchange of sea/brackish water and domestic wastewater for potable water production.

FIG. 1B provides a schematic of prior art methods of conventional desalination for desalinating first sea/brackish water and a second sea/brackish water for potable water production.

FIG. 2 provides a schematic for a system of salinity exchange electrodialysis (SEE) in operation, in accordance with an exemplary embodiment of the present disclosure.

FIG. 3A provides a plot for voltage profile and salinity change of seawater streams (0.6 M NaCl) and domestic wastewater streams (0.01 M NaCl) in a typical SEE operation verse time, and FIG. 3B provides a plot energy consumption of the SEE process at different current densities verse current densities, in accordance with an exemplary embodiment of the present disclosure.

FIGS. 4A-4D provide plots of the performance of SEE process with different feed streams, in accordance with an exemplary embodiment of the present disclosure.

FIGS. 5A-5F provide plots of SEE operation with varying current densities, in accordance with an exemplary embodiment of the present disclosure.

FIGS. 6A through 6C provide plots of SEE performance under varying current densities, in accordance with an exemplary embodiment of the present disclosure. FIG. 6A provides energy efficiencies for phases 1 and 2 calculated across varying current densities. As shown, both phase 1 and 2 energy efficiencies decrease with increasing current density. The highest current densities (5 & 10 mA/cm²) resulted in a negative phase 1 energy efficiency because the movement of ions occurred too quickly to observe an energy generation. FIG. 6B provides final volume desalinated water produced and the proportional water recovery percentage across varying current densities. FIG. 6C provides coulombic efficiency across varying current densities.

FIGS. 7A-7D provide plots of SEE operation for varying circulation flow rate, in accordance with an exemplary embodiment of the present disclosure. The curve represents the measured voltage over time, while the triangles represent the measured salinity values of Stream I and II at the beginning and end of a completed salinity exchange process. The circulation flow rate for each run is listed at the top of each subfigure.

FIGS. 8A-8D provide plots of SEE operation across different flow rates, in accordance with an exemplary embodiment of the present disclosure. FIG. 8A provides energy consumption of the SEE process across various circulation flow rates (50-200 mL/min). FIG. 8B provides energy efficiency of phases 1 and 2 verse different circulation flow rates. FIG. 8C provides final volume desalinated water produced and proportional water recovery percentage across varying circulation flow rates. The proportional water recovery percentage is also shown. FIG. 8D provides coulombic efficiency for varying circulation flow rate.

FIGS. 9A-9F provide SEE operation for varying NaCl concentration of Stream I, in accordance with an exemplary embodiment of the present disclosure. The curve represents the measured voltage over time, while the triangles represent the measured salinity values of Stream I and II at the beginning and end of a completed salinity exchange process. The initial NaCl concentration of Stream I for each run is listed at the top of each subfigure.

FIG. 10A-10C provide plots for SEE performance over different NaCl concentrations of Stream I, in accordance with an exemplary embodiment of the present disclosure. FIG. 10A provides energy efficiencies for phases 1 and 2 calculated for varying Stream I NaCl concentrations. As shown, both phase 1 and 2 energy efficiencies decrease with decreasing Stream I concentrations. The lowest Stream I concentration (0.1 M) resulted in a negative phase 1 energy efficiency because there was not enough salinity gradient between Stream I and II to observe an energy generation. FIG. 10B provides final volume desalinated water produced for varying NaCl concentrations of Stream I. The proportional water recovery percentage is also shown. FIG. 10C provides Coulombic efficiency for varying NaCl concentrations of Stream I.

FIG. 10D provides a plot for energy consumption of the SEE process with various initial NaCl concentrations of Stream I (0.1-0.6 M) and a fixed initial NaCl concentration of Stream II (0.01 M), in accordance with an exemplary embodiment of the present disclosure.

FIG. 11A-C provide SEE operation for varying NaCl concentration of Stream II, in accordance with an exemplary embodiment of the present disclosure. The curve represents the measured voltage over time, while the triangles represent the measured salinity values of Stream I and II at the beginning and end of a completed salinity exchange process. The initial NaCl concentration of Stream II for each run is listed at the top of each subfigure.

FIG. 12A-12C provide plots for SEE performance over different NaCl concentrations of Stream II, in accordance with an exemplary embodiment of the present disclosure. FIG. 12A provides energy efficiencies for phases 1 and 2 calculated for varying Stream II NaCl concentrations. FIG. 12B provides final volume desalinated water produced for varying NaCl concentrations of Stream I. The proportional water recovery percentage is also shown. FIG. 12C provides coulombic efficiency for varying NaCl concentrations of Stream II.

FIG. 12D provides a plot for energy consumption of the SEE process with various initial NaCl concentrations of Stream I (0.6 M) and a fixed initial NaCl concentration of Stream II (0.01-0.003 M), in accordance with an exemplary embodiment of the present disclosure.

FIG. 13A provides a plot for energy consumption of conventional electrodialysis (CE) processes with both streams of 0.6 M NaCl at different current densities, in accordance with an exemplary embodiment of the present disclosure.

FIG. 13B provides a plot for final volume of desalinated water produced and proportional water recovery percentage for SEE and conventional electrodialysis (CE) across varying current densities, in accordance with an exemplary embodiment of the present disclosure.

FIG. 14 provides a schematic of salinity exchange battery (SEB) operation, in accordance with an exemplary embodiment of the present disclosure.

FIG. 15 provides a schematic of a salinity exchange battery cell, in accordance with an exemplary embodiment of the present disclosure.

FIG. 16 provides images of SEM of a CuHCF electrode, in accordance with an exemplary embodiment of the present disclosure.

FIG. 17 provides a plot of XRD patterns of CuHCF from co-precipitation, in accordance with an exemplary embodiment of the present disclosure.

FIGS. 18A through 18D provide plots of electrochemical characterizations of CuHCF electrodes, in accordance with an exemplary embodiment of the present disclosure. FIG. 18A provides CV, FIG. 18B provides EIS, FIG. 18C provides galvanic charge-discharge curves, and FIG. 18D provides cycling performance.

FIGS. 19A through 19F provide images of SEM of the PPy coated carbon cloth resulted from electrodeposition of 2 h (FIGs. A, B), 4 h (FIGs. C, D), and 6 h (FIGs. E, F), in accordance with an exemplary embodiment of the present disclosure.

FIGS. 20A and 20B provide plots for narrow C1s and N1s spectra of the PPy electrode, in accordance with an exemplary embodiment of the present disclosure.

FIGS. 21A through 21D provide plots of electrochemical characterizations of PPy electrodes, in accordance with an exemplary embodiment of the present disclosure. FIG. 21A provides CV, FIG. 21B provides EIS, FIG. 21C provides galvanic charge-discharge curves, and FIG. 21D provides cycling performance.

FIG. 22 provides salinity and voltage change during the charging and discharging of an SEB in operation.

FIG. 23 provides capacity retention of the electrodes over 1000 charge-discharge cycles at 1 mA/cm². FIG. 23A provides the retention for CuHCF electrodes. FIG. 23B provides the retention for PPy electrodes.

FIG. 24 provides salinity exchange operation with SEB at 5 mA for 5 cycles.

FIG. 25 provides a flowchart of an example method for purifying salt water, in accordance with an exemplary embodiment of the present disclosure.

FIG. 26 provides a flowchart of an example method for purifying salt water, in accordance with an exemplary embodiment of the present disclosure.

### DETAILED DESCRIPTION

Although certain embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. Other embodiments of the disclosure are capable of being practiced or carried out in various ways. Also, in describing the embodiments, specific terminology will be resorted to for the sake of clarity. It is intended that each term contemplates its broadest meaning as understood by those skilled in the art and includes all technical equivalents which operate in a similar manner to accomplish a similar purpose.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified.

The components described hereinafter as making up various elements of the disclosure are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

Integrating traditional desalination techniques, direct potable reuse of wastewater, and harvesting of salient gradient energy introduces a new concept called “salinity exchange.” Some of the advantages of salinity exchange can include: 1) lower energy consumption than conventional desalination technologies; 2) no brine generation; and 3) drinking desalinated seawater is much more cognitively appealing than the DPR of treated wastewater.

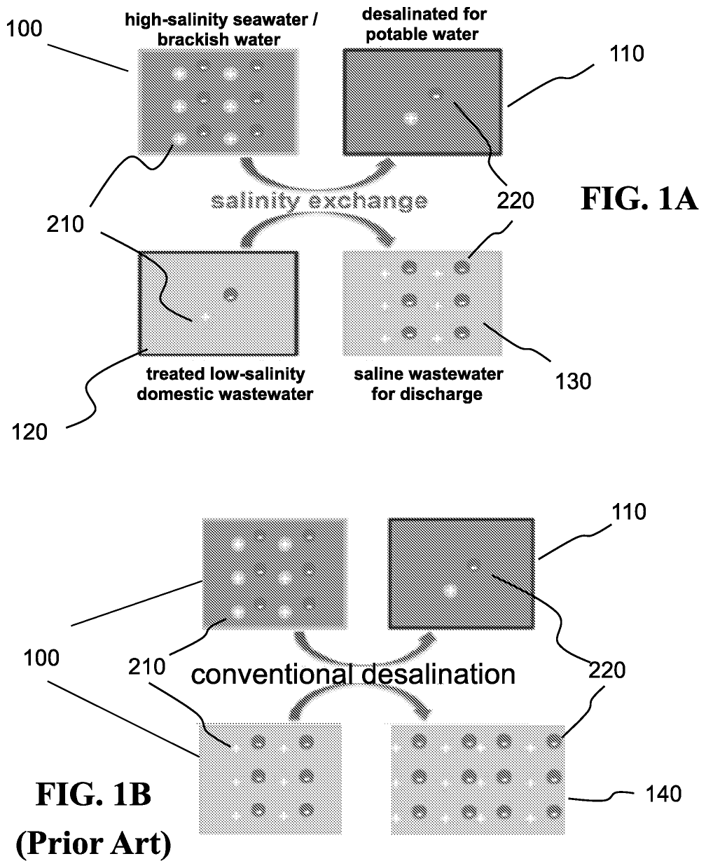

As shown in FIG. 1A, starting from seawater 100 and treated low-salinity domestic wastewater 120, electrochemical approaches can be applied to transfer salt via dissolved salt ions 210 and 220, in seawater 100, to treated wastewater 120, so that the end products will be high-salinity treated wastewater 110, and low-salinity seawater 130. The high-salinity wastewater 130 can be discharged to the ocean directly, given that the wastewater has been treated to meet the discharge standard. The low-salinity seawater 110 can be further treated to produce potable water.

Compared with conventional desalination, such as shown in FIG. 1B, the salinity exchange process can produce potable water with much less energy consumption. Instead of having the minimum energy required to overcome the thermodynamic limit for conventional desalination technologies, the salinity exchange process can consume energy in terms of electrochemical over-potential to move the dissolved salt ions 210 and 220. In addition, because the removed salt can be directly “diluted” by the low-salinity wastewater 120, the salinity exchange process may not generate any brine 140, which, if not handled appropriately, may cause environmental and ecological issues. Compared with DPR of treated domestic wastewater 120, drinking desalinated seawater 110 can be much more cognitively appealing. The quality of the potable water produced by the salinity exchange process can be easily treated to meet drinking water standards. The water produced by most conventional desalination technologies is actually too “clean” for human health, and adding minerals back to the desalinated water is usually required for potable use. Such an inefficient and energy-wasting step may not be needed for the potable water produced by salinity exchange since the ion concentration can be well controlled. Producing potable water through salinity exchange is particularly promising in coastal areas where seawater is readily available, and wastewater is typically discharged to the ocean after treatment anyway. Considering that more than 1,400 wastewater treatment plants, serving more than one-third of the US population, discharge approximately 10 billion gallons of treated effluent per day, the potential impact of salinity exchange is significant.

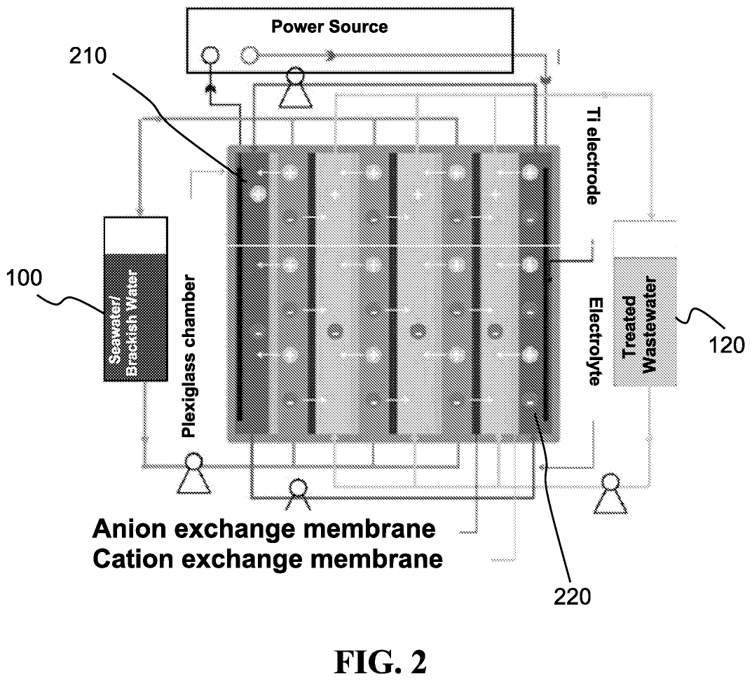

In some embodiments, as shown in FIG. 2., salinity exchange can be achieved by Salinity Exchange Electrodialysis (SEE) through an integrated system of reversed electrodialysis (RED) and electrodialysis (ED) forming an electrodialysis cell. Synthetic or real seawater 100 and treated wastewater 120 can be separated by selective ion exchange membranes, while the transport of salts can be driven by the combination of Donnan potential and electric potential.

In some examples, the electrodialysis cell can comprise pairs of ion exchange membranes (IEMs, e.g., half can be anion exchange membranes and half can be cation exchange membranes). The IEMs can be separated by spacers to form chambers. The chambers can be alternately filled with high-salinity (concentrate) and low-salinity (dilute) feeds. The two side chambers can be equipped with an electrode each and filled with electrode rinse solution that can circulate through the two electrode chambers. The electrodes can be in electrical communication with each other and with a power source. The electrodes can comprise one or more metals or other conductors or semiconductors. The one or more metals can be any known conductor, such as titanium.

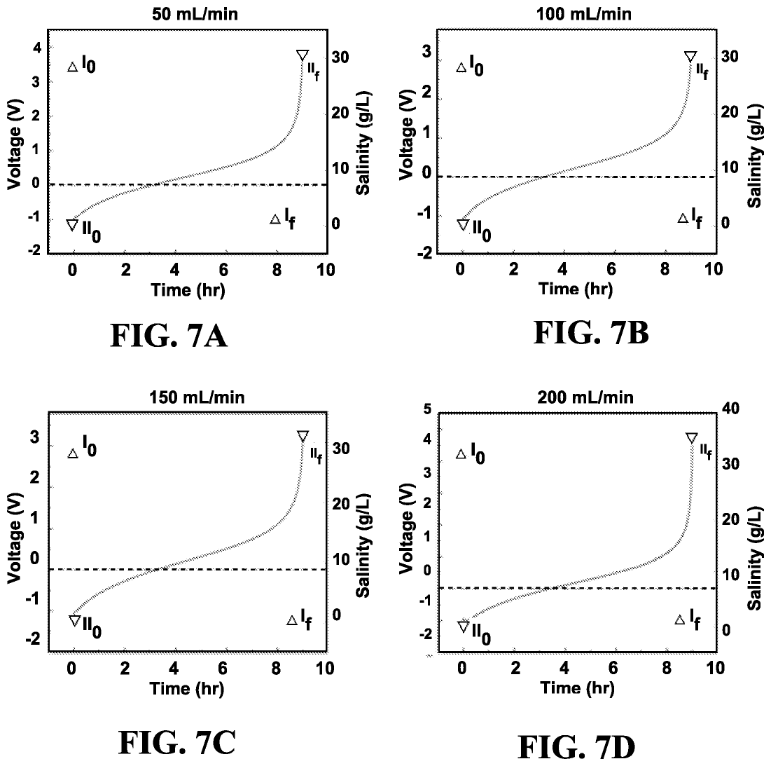

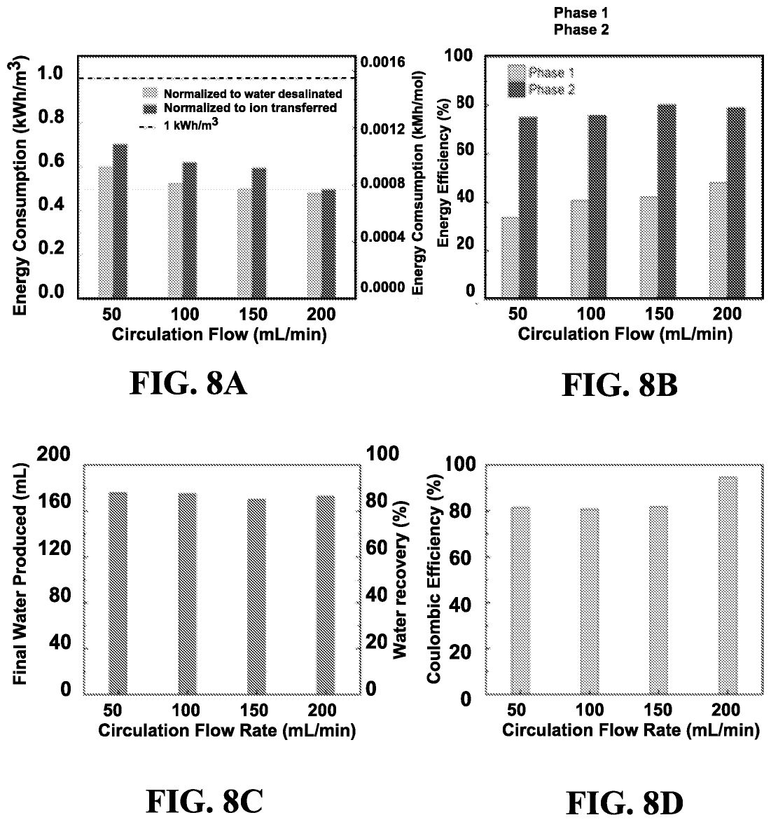

The high-salinity feed (Stream I) can comprise seawater, brackish water, or synthetic waters. The high-salinity feed can have many different salt concentrations. In some embodiments, the high-salinity feed can have a salt concentration (e.g., NaCl, any other salts, or any combinations of salts) of from 0.1˜0.6 M. The low-salinity feed (Stream II) can comprise domestic treated wastewater or synthetic waters. In some embodiments, the low-salinity feed can have a salt concentration (e.g., NaCl, any other salts, or any combinations of salts) from 0.01˜0.03 M. As shown in FIGS. 7A-7D the feed streams flow rates for the high-salinity and low-salinity feeds can vary. In some embodiments, the feed streams flow rates for the high-salinity and low-salinity feeds can vary from 50 to 200 mL/min.

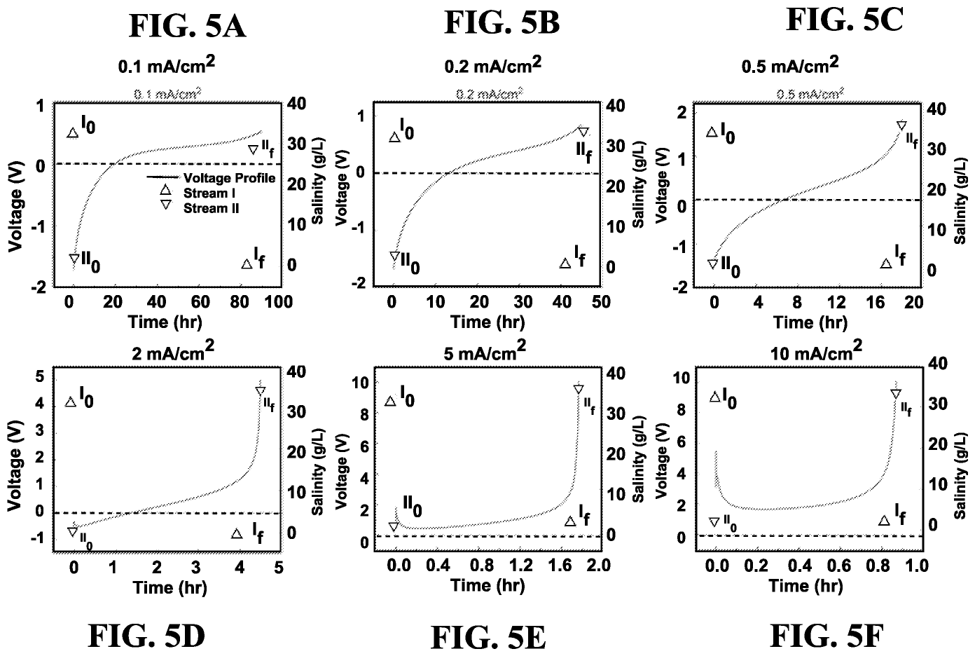

As shown in FIGS. 5A-5F, a range of current densities (0.1-10 mA/cm²) can be applied to the SEE system.

The operation of the SEE can include two phases. At the transition point from phase 1 to phase 2, the two streams can reach substantially the same salt concentration. Phase 1 covers the reverse electrodialysis process for moving the salt concentrations between the two streams. Phase 2 covers the electrodialysis process for moving the salt concentrations between the two streams.

A further exemplary embodiment can be described in the form of Salinity Exchange Battery (SEB) systems for desalinating water. As shown in FIG. 14, the approach of salinity exchange using a battery system can comprise the following five steps: i) placing electrochemically active electrodes 500 (one for Na⁺ and the other for Cl⁻) into seawater 100; ii) charging the electrodes 500 by applying a controlled current, during which, e.g., Na⁺ and Cl⁻, are intercalated into the electrodes 500; iii) taking out the electrodes 500 from seawater 100 crating a low-salinity seawater 120 and immersing the electrodes 500 into treated domestic wastewater 110; iv) discharging the electrodes 500 by applying a reversed current, during which the Na⁺ and Cl⁻ are released to the wastewater 110 forming a high-salinity wastewater 130; and v) removing the electrodes 500, which are ready for another cycle of salinity exchange.

While the present disclosure has been described in connection with a plurality of exemplary aspects, as illustrated in the various figures and discussed above, it is understood that other similar aspects can be used, or modifications and additions can be made to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

### Exemplary Use Cases

The following examples are provided by way of illustration but not by way of limitation.

Exemplary embodiments will now be described in the form of SEE and SEB systems for desalinating water. Referring back to FIG. 2, the electrodialysis cell for SEE can comprise pairs of ion exchange membranes (IEMs, i.e., half are anion exchange membranes and half are cation exchange membranes). The IEMs can be separated by spacers to form chambers. The chambers can be alternately filled with high-salinity (concentrate) and low-salinity (dilute) feeds. The two side chambers can be equipped with at least one electrode each and filled with electrode rinse solution that can circulate through the two electrode chambers. In some examples the electrodialysis cell can comprise 10 pairs of IEMs, each with an effective area, e.g, 36 cm², the IEMs can be separated by spacers with thickness 0.027 cm to form 20 chambers, making the total effective volume for salinity exchange ˜20 mL, the electrodes can be made of Ti mesh, rinse solution can comprise (0.05 M K₃Fe(CN)₆, 0.05 M K₄Fe(CN)₆·3H₂O, and 0.25 M NaCl).

The high-salinity feed can comprise seawater, brackish water, or synthetic waters of, e.g., (0.1˜0.6 M) NaCl, while the low-salinity feed can comprise domestic treated wastewater or synthetic waters of, e.g., (0.01˜0.03 M) NaCl.

In an exemplar embodiment, the default conditions for SEE operation comprised a feed solution flow rate: 200 mL/min, Stream I NaCl concentration: 0.6 M, Stream II NaCl concentration: 0.01 M, applied current density: 1 mA/cm², operating time: 9 hours. The flow rate for the electrode rinse solution is fixed at 100 mL/min. The device operates under room temperature (˜25° C.) and the voltage across the 10 membrane pairs can be monitored.

In some embodiments, the system can include a range of flow rates, current densities, feed concentrations, and complex water matrices. Salinity exchange can be conducted between 200 mL of feed solutions (ranging from 0.6 M˜0.01 M dilute) over the 7 different applied current densities (0.1, 0.2, 0.5, 1, 2, 5, 10 mA/cm²). A default 1 mA/cm² current density can be applied across all varying feed concentrations.

The operation of the SEE includes two phases. At the transition point from phase 1 to phase 2, the two streams reach the same salt concentration (C₀). For theoretical phase 1 energy generation, the calculation is based on the free energy of mixing using Eq. 1, where R_{g} is the universal gas constant, T is the absolute temperature, c_{I} and c_{II} are the initial solute concentrations for the Stream I and Stream II, and φ is the dilution ratio defined as V_{d}/V_{c} which was considered 1. Default conditions of c_{I} and c_{II} were 0.6 M and 0.01 M.

$$Δ {E}_{m i x} = 2 {R}_{g} T ( {c}_{I} ln \frac{{c}_{I} ( 1 + φ )}{{c}_{I} + φ {c}_{II}} + φ {c}_{II} ln \frac{{c}_{II} ( 1 + φ )}{{c}_{I} + φ {c}_{II}} ) \qquad ( 1 )$$

The minimum energy consumption for desalination was calculated based on Eq. 2, where R_{g} is the ideal gas constant, T is the absolute temperature, γ is the water recovery rate (considered 50% in this system since the volumes of both Stream I and Stream II are initially equivalent), C₀ is the initial concentration of both Stream I and Stream II at the beginning of phase 2, C_{If} is the Stream I effluent concentration, and C_{IIf} is the Stream II effluent concentration. If C₀ is replaced with (C_{If}+C_{IIf})/2, Eq. 1 and Eq. 2 are the same, which is logical considering the salt transfer process (phase 2) is just the reverse of the previous spontaneous mixing (phase 1). Due to the water transfer observed within the SEE system, the theoretical minimal energy consumption was calculated using the endpoint effluent concentration of Stream I (final desalinated water produced). This final desalinated water concentration was used to obtain the theoretical effluent concentration of Stream II, and the midpoint of these 2 effluent concentration values was used to represent C₀ in each case. This point of equilibrium determined where phase 1 ended and phase 2 began. Ideally the system would reach equilibrium at half the operating time t, but due to the overpotential and water transfer, the EG phase is observed to be shorter.

$$E {C}_{min} = 2 {R}_{g} T \{ \frac{{c}_{0}}{γ} ln [ \frac{{c}_{If}}{{c}_{0}} ] - {c}_{IIf} ln [ \frac{{c}_{If}}{{c}_{IIf}} ] \} \qquad ( 2 )$$

The real energy generation and consumption were calculated based on Eq. 3, where I_{c} is constant current applied and V_{cell} is the voltage potential over time. Negative values correlated to energy generation, while positive values correlated to energy consumption. Due to the water leakage in the SEE system, the effluent concentrations were used similarly as in Eq. 2 to calculate the equilibrium midpoint.

$$EC = {I}_{c} {\int }_{{t}_{0}}^{{t}_{f}} {V}_{c e l l} ( t ) dt \qquad ( 3 )$$

The energy generation efficiency for phase 1 can be calculated by the fraction of real energy generated over the theoretical, while the energy consumption efficiency for phase 2 can be calculated by the fraction of theoretical energy consumption over the real energy consumed. The energy consumption can be calculated and normalized to the mols of ions transferred for each operating condition. After assessing the water leakage, the EC can also be normalized to the volume of treated water produced.

In electrodialysis systems not all the current is always used effectively, and back diffusion of ions or co-ion transport can occur due to imperfect membranes. The coulombic efficiency can be calculated as the total electric charge transported by ions over the electric charge transported applied to the system. This was based on Eq. 4, where n is the moles of ions transferred, F is the Faraday's constant of 96485 C/mol, I_{c} is constant current, and t is the operation time.

$$CE = \frac{n F}{{I}_{c} t} ( 4 ) \qquad ( 4 )$$

Laboratory-scale SEE systems have been operated under various conditions to verify the advantages of the salinity exchange process, compare its feasibility against state-of-the-art RO, and identify the challenges for the application of salinity exchange in practical drinking water production.

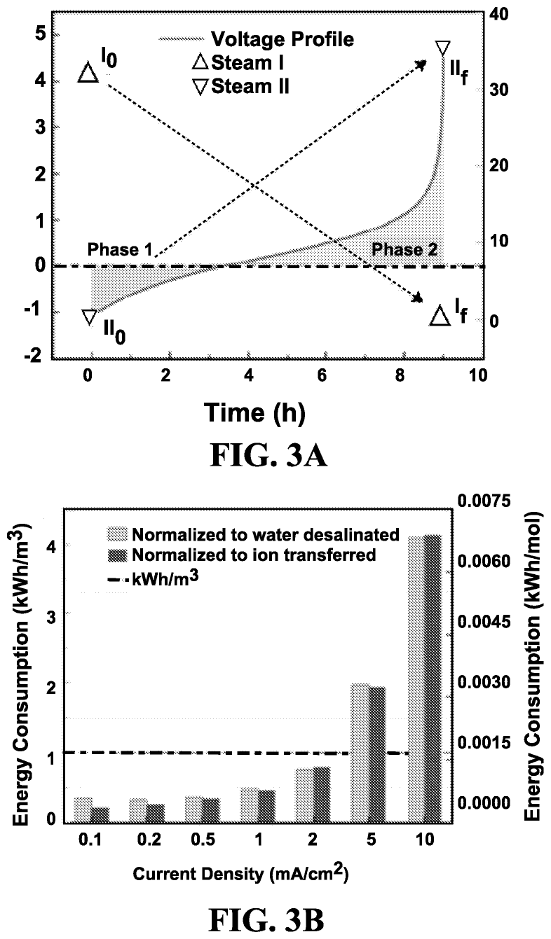

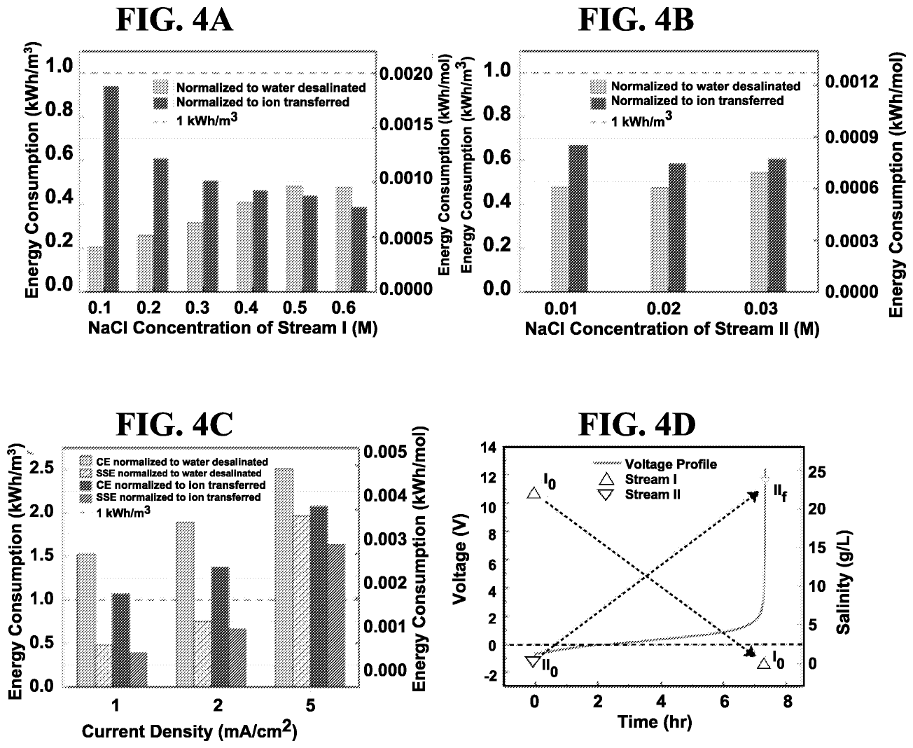

In some embodiments, salinity exchange between Stream I, e.g., (200 mL NaCl solution, ˜0.6 M, representing seawater) and Stream II, e.g., (200 mL NaCl solution, ˜0.01 M, representing treated domestic wastewater) can be achieved using an electrodialysis cell. Salinity exchange electrodialysis (SEE) can be operated at a current density of 1 mA/cm² for 9 hours. During this process, water transport across the ion-exchange membranes as osmosis and/or electro-osmosis could be observed, which was also reported in other electrodialysis processes. As a result, the volume of Stream I first increased and then decreased, while Stream II behaved oppositely. The final volumes of Streams I and II were measured to be 176 and 226 mL, respectively. As shown in FIG. 3A, the salinity of Stream I decreases from 32.45 to 0.42 g/L, while the salinity of Stream II increases from 0.70 to 35.54 g/L, demonstrating almost complete salinity exchange (salinity values are corrected according to the final volumes of the two streams.

Further shown in FIG. 3A, is the voltage profile of the SEE operation in certain embodiments. Based on the theoretical entropy change linked to the salinity, the SEE process should generate energy in the first half phase and consume energy in the second half phase of operation. However, mainly due to the energy needed to move the ions and overcome the ohmic resistance of the system, the net energy generation was only observed in the first 3.5 hours of the total 9-hour operation, indicated by the negative voltage shown in FIG. 3A. The observed water transport also diluted Stream I in the first half phase, shortening the energy generation. The coulombic efficiency, indicating how much current flow was used to move ions, was calculated to be 95%, which is within the high range (80-100%) according to previous literature.

The energy generation/consumption of the two phases of SEE operation can be first assessed separately. According to the salinity values of the streams before and after SEE, the theoretical energy generation in the first half phase and consumption in the second half phase are 369 and 380 J, respectively. Determined by the voltage profile shown in FIG. 3A, the practical energy generation and consumption in these two phases are calculated to be 178 and 481 J, which result in energy efficiencies of 48% and 79%, respectively. For the whole SEE process, the overall energy consumption is 303 J, or 0.48 kWh/m³ if normalized to the volume of water desalinated (176 mL). Such an energy consumption is about half of that for state-of-the-art RO (˜1 kWh/m³), an order of magnitude less than conventional SWRO (3-5 kWh/m³), and lower than the thermodynamic limit of seawater desalination (0.78 kWh/m³). If normalized to the moles of ions transferred during the SEE process, the specific energy consumption (SEC) is calculated to be 0.00077 kWh/mol, which is around an order to magnitude lower than that for conventional electrodialysis for seawater desalination (˜0.0055 kWh/mol).

After the success of SEE operation with low energy consumption was demonstrated in some embodiments, further embodiments of the system were tested using a range of current densities (0.1-10 mA/cm²) to decrease/increase the rate of salinity exchange as shown in FIGS. 5A-5F. Under all current conditions, the system achieved near-complete salinity exchange. As shown in FIG. 3B, the overall energy consumption normalized to either the volume of water desalinated or moles of ions transferred for each tested current density. As the current controls the speed of ion transfer, with higher current, salinity exchange can be achieved more quickly, but the overpotential for driving ions, i.e., the energy consumption, can be higher. Further shown in FIG. 3B, the SEE process can consume less than 1 kWh/m³ of desalinated water at applied current densities of 0.1-2 mA/cm². For current densities higher than 2 mA/cm², the energy consumption is >1 kWh/m³, and the salinity exchange occurs too quickly to observe a net energy generation phase as the voltage profile is consistently positive as shown in FIGS. 5A-5F.

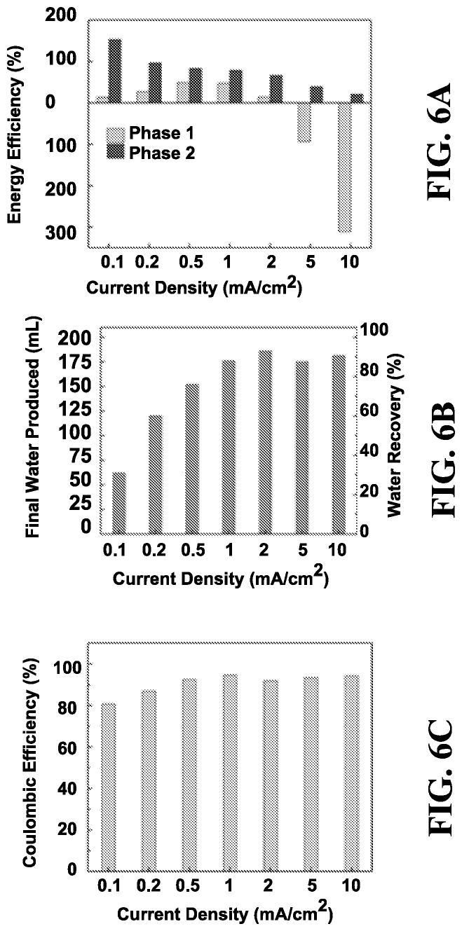

As shown in FIG. 6A, separate energy analysis was also conducted for the two phases of the SEE operation at different current densities for some embodiments. Generally, smaller current densities, i.e., slower salinity exchange, required lower energy consumption and showed higher energy efficiencies. However, as shown in FIG. 6B, lower current densities resulted more significant water transport across the ion-exchange membrane, leading to less volume of desalinated water produced. The coulombic efficiency also slightly decreases with lower current density applied, this result is comparable to previous studies that have observed similar relationships. The relationship between coulombic efficiency and current density is reliant upon the concentration gradient over the membrane and the back diffusion of ions. As shown in FIG. 6C, because of back diffusion of ions can occur at lower current density, the coulombic efficiency can be impacted.

Previous work found that at lower applied current densities, the osmotic water transport increases significantly. This agrees with the findings that the water loss can be directly correlated with the applied current density, and therefore, the time to transport ions in solution. Because of this, higher current densities resulted in the least amount of water loss as the time to transport ions was much less. The water transport in SEE tapered off at ˜10% total volume for higher current densities (above 1 mA/cm²). Previous literature supports this observation as several studies have found water transport to decrease with increasing current and approach a limiting value.

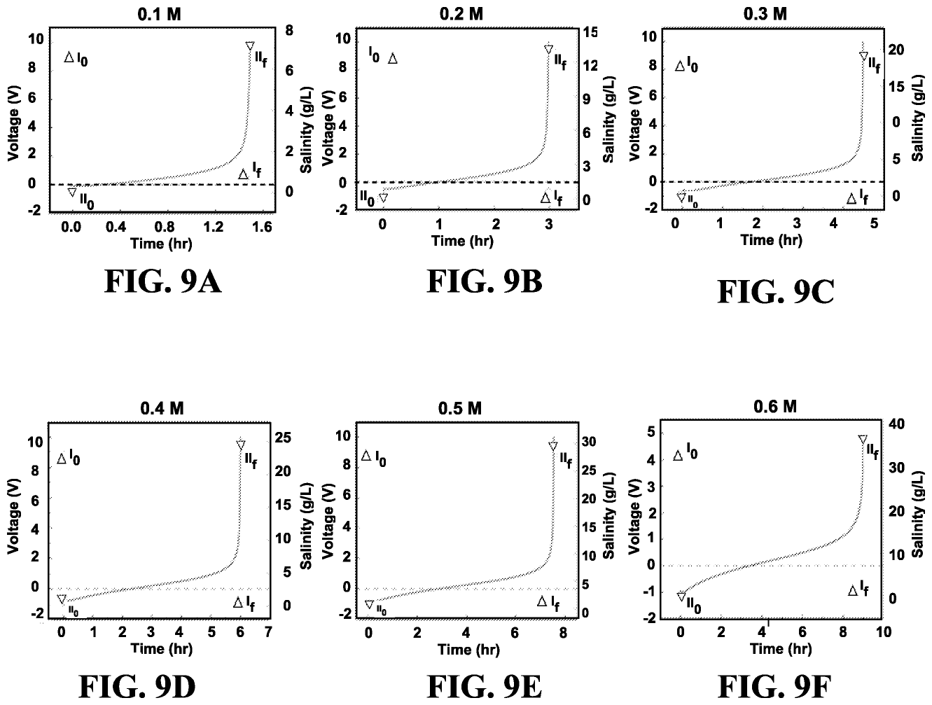

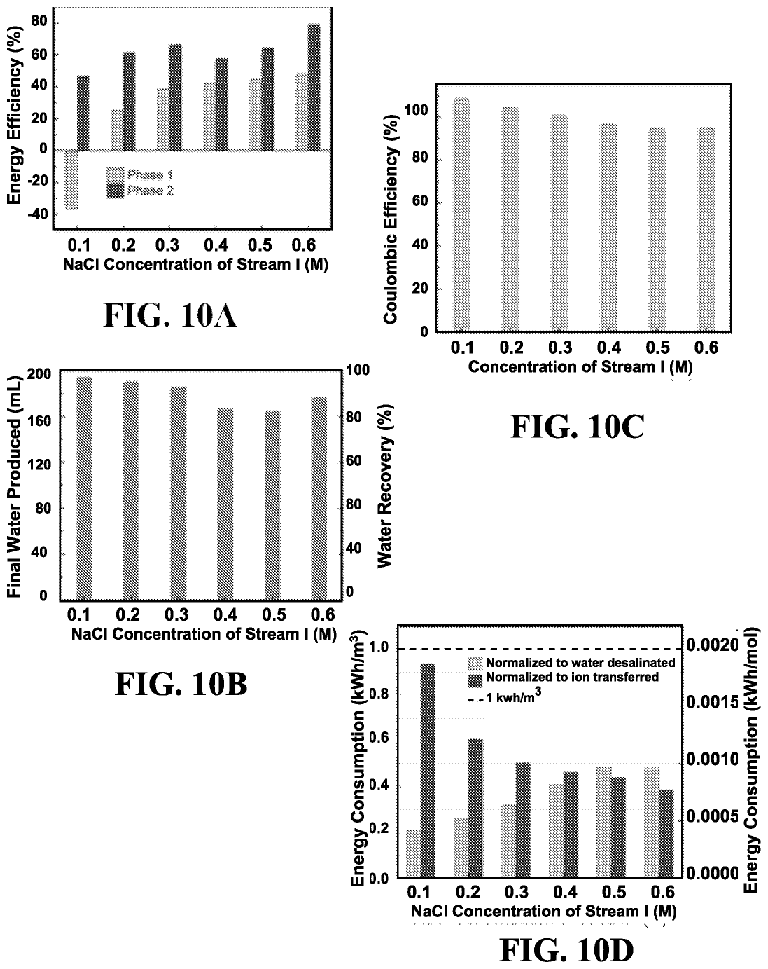

FIGS. 9A-9F provide simulations of the salinity exchange between brackish water and treated domestic wastewater in some embodiments of the disclosure. The SEE system was tested with an initial NaCl concentration of Stream I varied from 0.1 to 0.6 M. Under all conditions tested, the system achieved near complete salinity exchange. As illustrated in FIG. 10A, when the NaCl concentration of Stream I decreased from 0.6 to 0.1 M, desalinated water produced increased from 176 to 194 mL because less ions are needed to be transferred, allowing shorter process time limiting any undesired water transport. The coulombic efficiency also increased, most likely due to the decline of concentration polarization phenomenon at lower salt concentrations. However, a lower initial NaCl concentration of Stream I resulted in lower conductivity and higher overpotential. This caused the energy efficiencies of both phases in SEE operation to decrease, and the overall energy consumption normalized to the ion transferred increased significantly from 0.00077 kWh/mol at 0.6 M to 0.0019 kWh/mol at 0.1 M as shown in FIG. 10B. Nevertheless, since Stream I with lower initial NaCl concentration required less amount of ion transfer to complete salinity exchange with Stream II, the energy consumption normalized to water desalinated is significantly lower, 0.21 kWh/m³ at 0.1 M vs 0.48 kWh/m³ at 0.6 M.

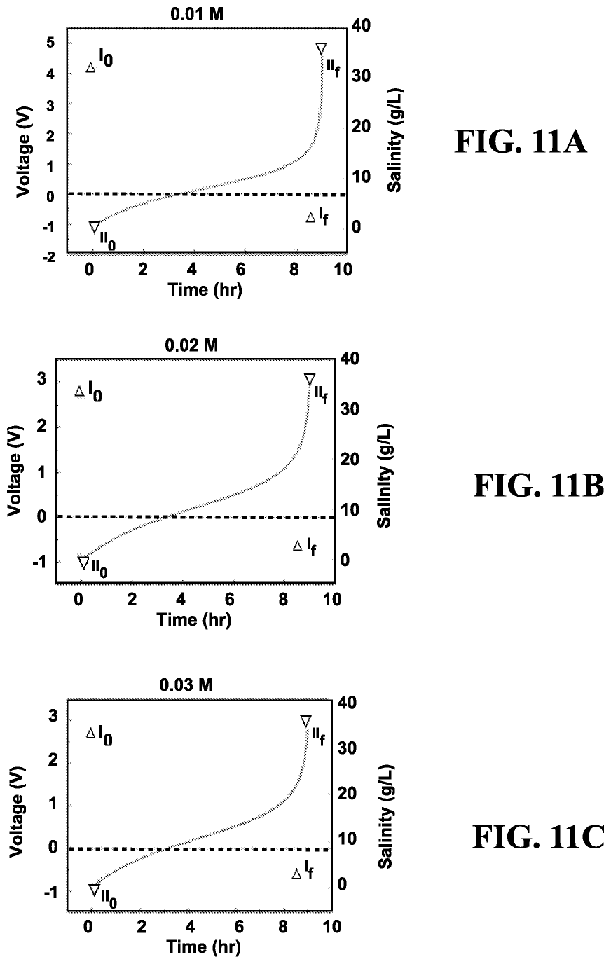

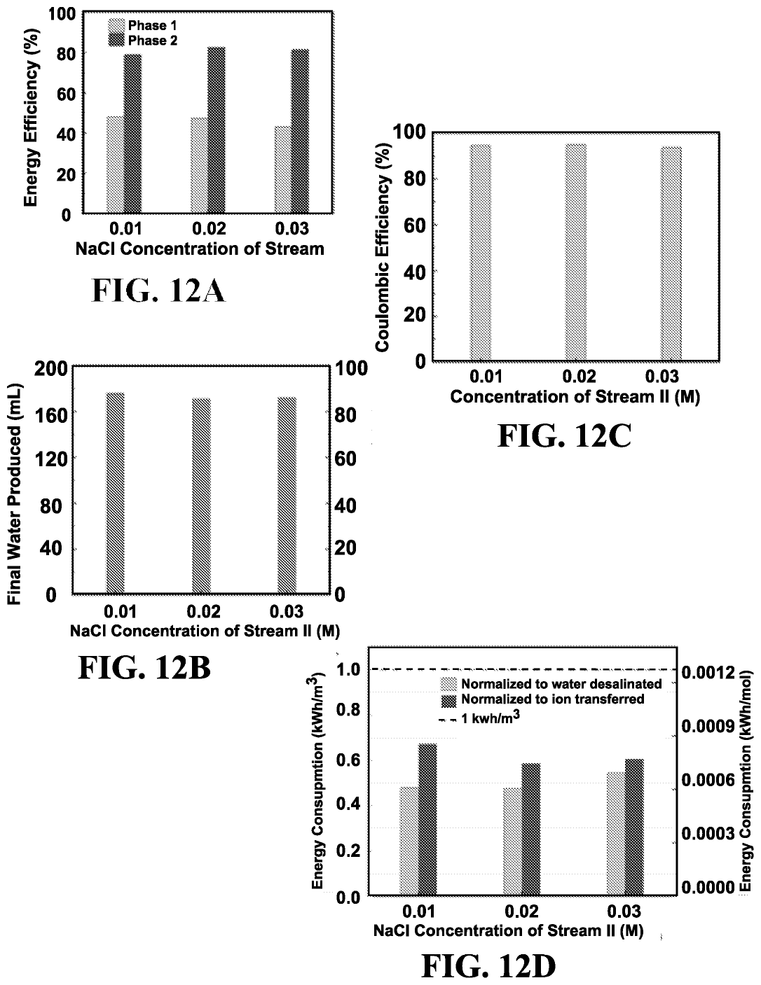

As illustrated in FIGS. 11A-11C, in an embodiment the SEE system was also tested with varying the NaCl concentration of Stream II from 0.01 to 0.03 M, simulating domestic wastewater with different salinity. Under these conditions, the performance of the SEE showed negligible impact, as shown in FIGS. 12A and 12B.

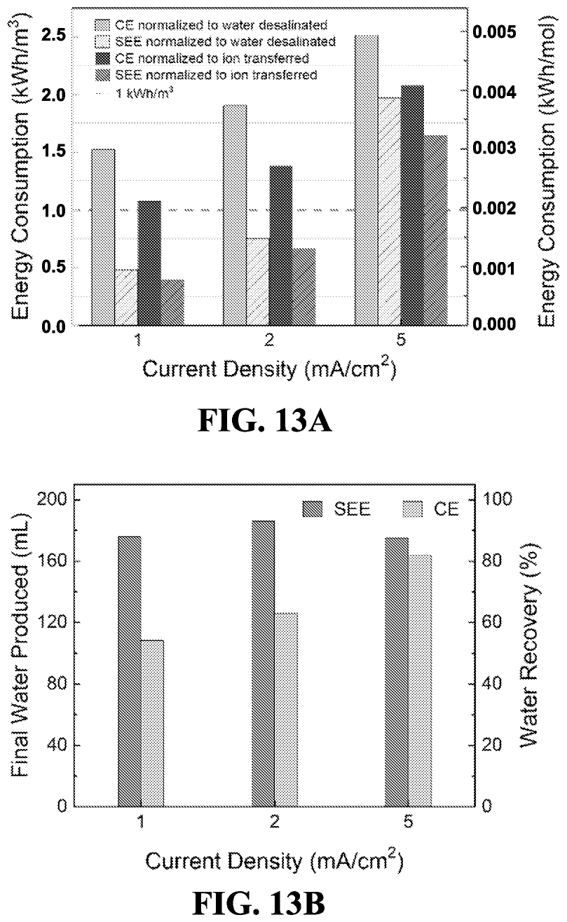

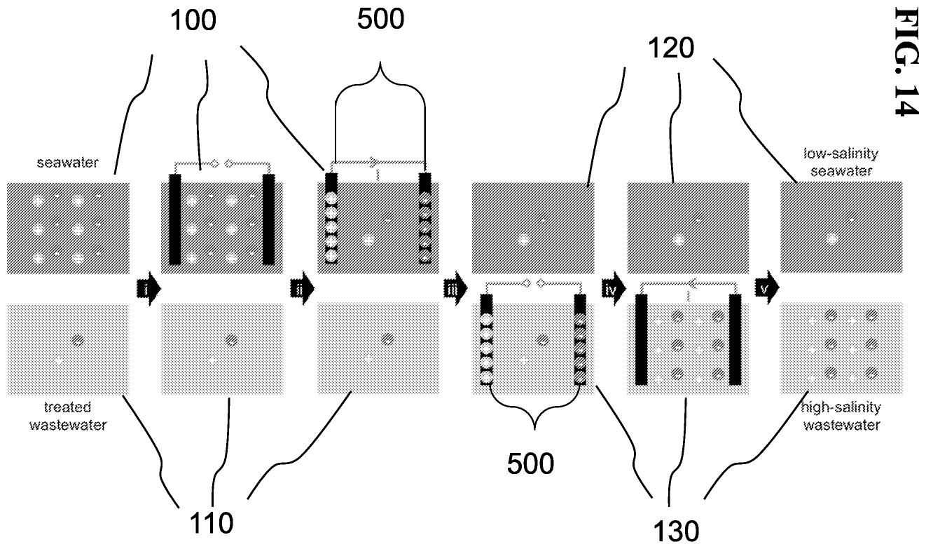

In additional embodiments, conventional electrodialysis desalination of seawater was also tested using the same device with both feed streams set as 0.6 M NaCl solution. As conventional electrodialysis cannot transfer salts using salinity gradient energy, it required more energy consumption to achieve the same level of desalination as SEE. As illustrated in FIG. 13A In all three current densities tested, the energy consumption was higher than 1 kWh/m³. FIG. 13B provides an observation of more water transport in conventional electrodialysis compared with SEE, which should be caused by the larger unfavorable osmotic pressure difference. The water recovery efficiency aligned with previous studies on conventional electrodialysis (typically 50-60%). Overall, although high-quality water production with conventional seawater desalination through electrodialysis could be achieved under the same current density applied, SEE could consume less energy and can produce potable water more efficiently.

In other embodiments, to demonstrate success in practical applications, the SEE system could be tested using real seawater (Stream I) and treated municipal wastewater (Stream II). The default conditions for SEE operation were used, and an effluent salt concentration lower than 0.015 M (˜0.9 g/L) was considered potable. In a ˜7-hour SEE operation, the salinity of the real seawater decreased from 22.09 g/L to 0.17 g/L. Although the initial salinity for the collected seawater was lower than predicted due to measurable dilutions observed from land drainage at the coastal areas of GA, complete salinity exchange with real water was still achieved. The water recovery maintained a high value >90%, while the coulombic efficiency was 76%. The energy consumption per volume of treated water produced was 0.59 kWh/m³ and per mol of ions transferred was 0.0014 kWh/mol. Although these numbers are slightly higher than that reported above with synthetic water streams, they are also much lower than that for state-of-the-art RO, demonstrating the success of SEE with real water application.

The low energy consumption of salinity exchange processes is mainly attributed to the harvest of salinity gradient energy. Salinity gradient energy results from the change in entropy when two solutions with different salinity are mixed (e.g., fresh water and seawater). The extraction of salinity-gradient energy can be achieved through membrane-based technologies, such as pressure-retarded osmosis (PRO) and reverse electrodialysis (RED). Recent studies have explored harnessing salinity gradient energy with RED utilizing the mixing of municipal wastewater effluent and seawater for clean, non-polluting, and sustainable energy production. However, it is still very challenging to efficiently store the recovered salinity gradient energy and result it commercially viable. The beauty of the salinity exchange process introduced here is that the recovered salinity gradient energy can be utilized in situ to subsidize the large energy needed for desalination. Unlike conventional RO or electrodialysis processes for seawater desalination that have a minimum energy consumption to overcome the thermodynamic limit, the salinity exchange process, theoretically, may not need to consume any energy. This can result from the salinity exchange process mainly consuming energy in terms of electrochemical overpotential to move the dissolved salts.

Another advantage of the salinity exchange process can be the absence of brine generation. Because the removed salt can be directly “diluted” by the low-salinity treated wastewater, the waste stream may not generate any brine, avoiding any unwanted environmental and ecological concerns associated with conventional desalination processes. In addition, the quality of potable water produced by salinity exchange can be easily treated to meet drinking water standards. The water produced by most conventional desalination technologies can be “too clean” for human health as minerals can be required to be added back into the desalinated water before human consumption. Such an inefficient and energy-wasting step may not be needed for the potable water produced by salinity exchange since the ion concentration can be well controlled. Lastly, when we compare DPR of treated domestic wastewater, drinking desalinated seawater can be much more cognitively appealing. Producing potable water through salinity exchange will be most applicable in coastal areas where seawater is readily available and wastewater is typically discharged to the ocean after treatment regardless. Considering that there are over 1,400 coastal wastewater treatment plants, serving more than one-third of the US population, discharging approximately 10 billion gallons of treated effluent per day, the potential impact of salinity exchange can be significant.

As electrodialysis is a membrane-based process, the properties of the ion-exchange membrane (IEMs) can be critical to the SEE performance. Upon material advances in the future, IEMs with higher ionic conductivity could enable faster salt transfer (i.e., higher water production rate) with less over electrochemical potential (i.e., lower energy consumption). IEMs are already expected to block most of the emerging contaminants in the wastewater from migrating to the desalinated seawater, so it is not of high concern, although potential cross-contamination of small and charged pollutants and fouling limitations at larger scales should be investigated in future studies.

Further exemplary embodiments will now be described in the form of SEB systems for desalinating water. As shown in FIG. 14, the approach of salinity exchange using a battery system can include the following five steps: i) place electrochemically active electrodes (one for Na⁺ and the other for Cl⁻) into seawater; ii) charge the electrodes by applying a controlled current, during which Na⁺ and Cl⁻ are intercalated into the electrodes; iii) take out the electrodes from seawater and immerse them into treated domestic wastewater; iv) discharge the electrodes by applying a reversed current, during which Na⁺ and Cl⁻ are released to the wastewater; and v) remove the electrodes, which are ready for another cycle of salinity exchange.

In an exemplar embodiment, Copper hexacyanoferrate (CuHCF) nanocrystal was chosen as the active material for sodium electrosorption, given its reported high charging rate and long cycle life. First the nanocrystal can be formed through a co-precipitation process. Briefly, make aliquots of 120 mL of 0.1 M Cu(NO₃)₂ and 120 mL of 0.05 M K₃Fe(CN)₆ solutions, respectively in two 200 mL beakers. Add the two solutions dropwise into a 500 mL beaker containing 60 mL of water simultaneously during constant stirring. Keep stirring for 24 hours, then allow the precipitation to settle for 24 hours. Centrifuge and collect the precipitant at 4000 rpm for 10 mins, and wash with DI water twice. Pour out the supernatant and keep the precipitant. Then, the as-prepared nanocrystals were coated onto carbon cloth as follows. Grind and mix the powders of CuHCF (75% wt/wt), carbon black (10% wt/wt), and PVDF (15% wt/wt) using the mortar and pestle. Disperse the mixture with NMP and mix it overnight with the mass ratio between the solid and solvent fixed at 10:1, then paste the slurry onto a piece of carbon cloth with a mass loading of at least 10 mg CuHCF per cm². Dry the electrode overnight in a vacuum at 60° C.

The PPy based chloride electrode was prepared by direct electropolymerization of pyrrole onto a piece of carbon cloth by a galvanostatic method (constant current). Carbon cloth was first immersed into 2 M H₂SO₄ for 24 hours to functionalize the surface with some carboxyl groups, making it more hydrophilic. A three-electrode mode including an Ag/AgCl reference electrode, a carbon cloth (2×2 cm²) working electrode, and a platinum counter electrode were used to conduct the electropolymerization. The electrolyte was a solution containing 0.1 M pyrrole and 1 M KCl. An anodic current of 2 mA/cm² was applied.

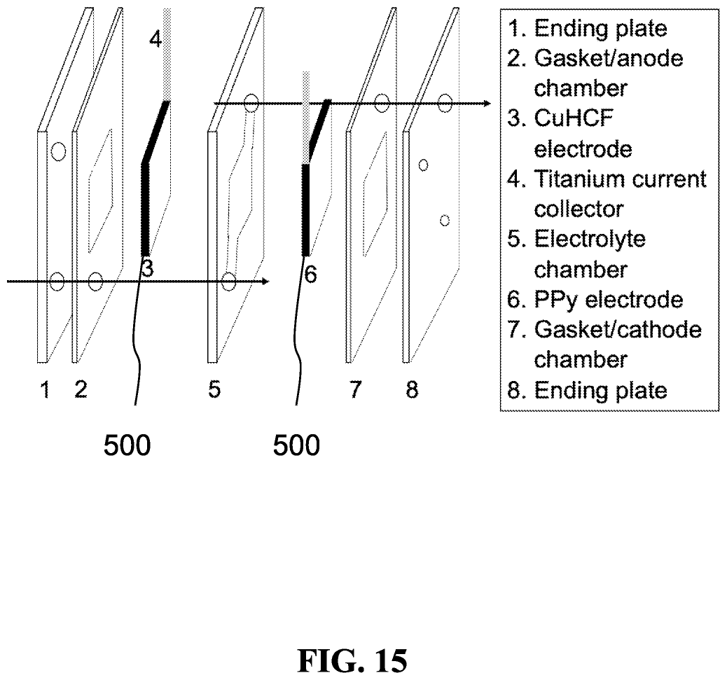

As shown in FIG. 15, the design of a SEB single cell for lower internal resistance of the cell, using a “sandwich” configuration to adopt for a smaller distance between the two electrodes. Because of the absorption selectivity of the sodium and chloride electrodes, no ion exchange membrane was needed to achieve the ion separation. For better contact and electron transfer, graphite/titanium sheets were used as current collectors.

Based on the design, in an exemplar embodiment, small prototype SEB cells were constructed using acrylic plates, rubber gasket, and other as-defined materials in the schematic. The effective area of each electrode is 2×2 cm², and the effective volume of the cell is ˜1 cm³. The channel etching and hole punching of the plates were performed by a laser cutting machine.

In another exemplar embodiment, a batch SEB cell with an electrode bundle system was developed to host more active electrode materials. In between each electrode pair, there was a PTFE mesh as the insulator to prevent short-circuiting. The electrode stacks were pressed together with two endplates. Finally, the electrode bundle was immersed into a certain volume feed solution matching its capacity to perform salinity exchange.

The CuHCF electrodes of 10×10 cm² were fabricated through the same active material slurry pasting technique. However, the even distribution of the active material across the whole carbon cloth throughout the pasting and drying processes was challenging. As for PPy chloride electrodes with the same scale, electrodeposition was used for fabrication. Due to the limited solubility of pyrrole in water, the large volume of electrolyte-containing pyrrole had to be well mixed in order to be evenly deposited on the carbon cloth. However, the vigorous mixing caused a disturbance in the system and therefore affected the electrodeposition of PPy. Also, a large amount of pyrrole in the electrolyte tends to self-polymerize and adhere to the walls of the container. The above challenges made the scaling up of the PPy electrodes using electrodeposition method infeasible.

The following salinity exchange exemplar embodiments using SEB systems were all conducted using the small prototype SEB cells. The test conditions were accommodated to the capacity of the cell.

The morphology and surface features of the electrodes were observed by scanning electron microscope (SEM) (Hitachi 8230) under 5 kV accelerating voltage. Elemental composition of the PPy electrode was measured by x-ray photoelectron spectroscope (XPS) (Thermo K-Alpha) using an Aluminum K-Alpha 1.486 KeV source. XRD was used to confirm the phase structure of the produced CuHCF precipitates. Electrochemical measurements for CuHCF and PPy were performed on flooded three-electrode setup with an electrolyte containing 1 M KNO₃ 0.01 M HNO₃ (pH=2), a CuHCF/PPy working electrode, a Ag/AgCl reference electrode, and a counter electrode containing a large mass of CuHCF/PPy as reversible sodium/chloride sink.

Single-cycle charge-discharge. An aliquot of 100 mL 700 ppm NaCl solution was circulated through the cell at 50 mL/min. The current density was 1 mA/cm². The conductivity of the stock solution was monitored by a conductivity probe. The conductivity of the influent was recorded before and after the charge and discharge cycles.

Cycling operation. For easy electrolyte switching and reduced mixing of the dilute and concentrated influents, the SEB operation was also conducted in a batch mode. Specifically, two electrodes were directly immersed in 80 mL of alternating electrolyte, ˜500 ppm NaCl for concentrated and ˜350 ppm for diluted, to achieve salinity exchange.

The energy consumption and coulombic efficiency were calculated using Eq. 3 and Eq. 4 described in Section 2.1.5.

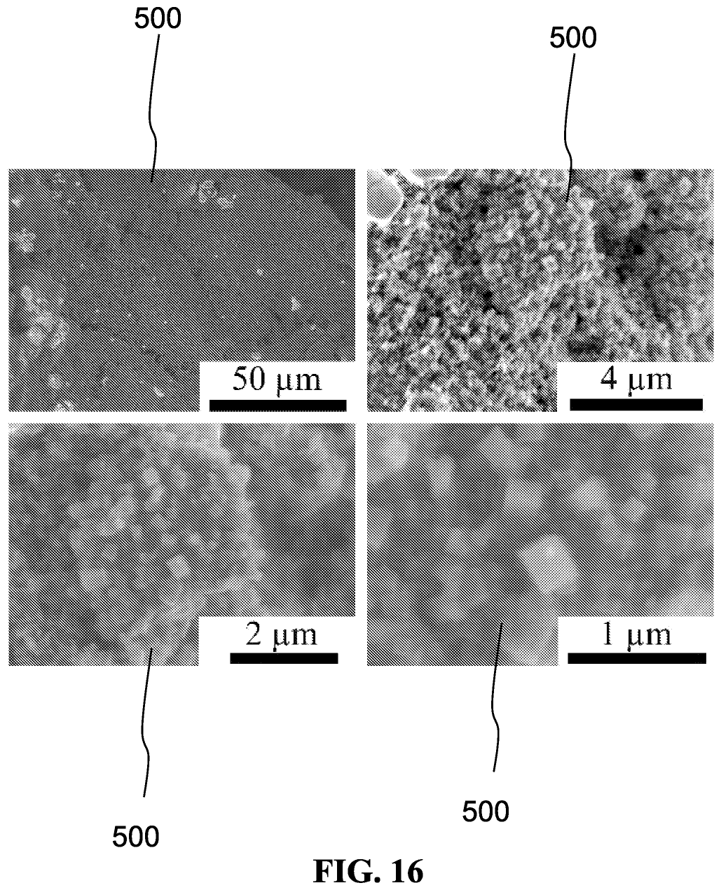

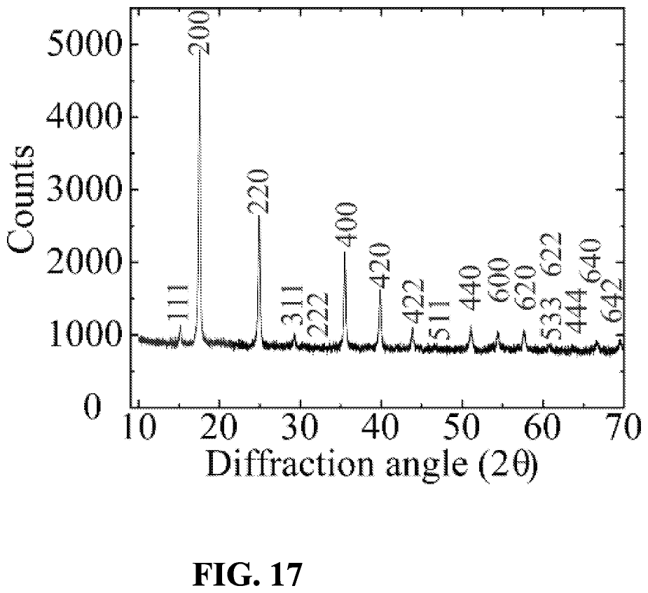

As shown in FIG. 16, SEM images of CuHCF electrodes are shown at different magnifications, with observable cubic crystal particles as described in the literature. The surface of the carbon cloth was fully covered by the active material. XRD was used to confirm the phase structure of the produced CuHCF precipitates. As illustrated in FIG. 17, the sharp peaks indicated the formation of highly crystalline structures, which is in accordance with the SEM images.

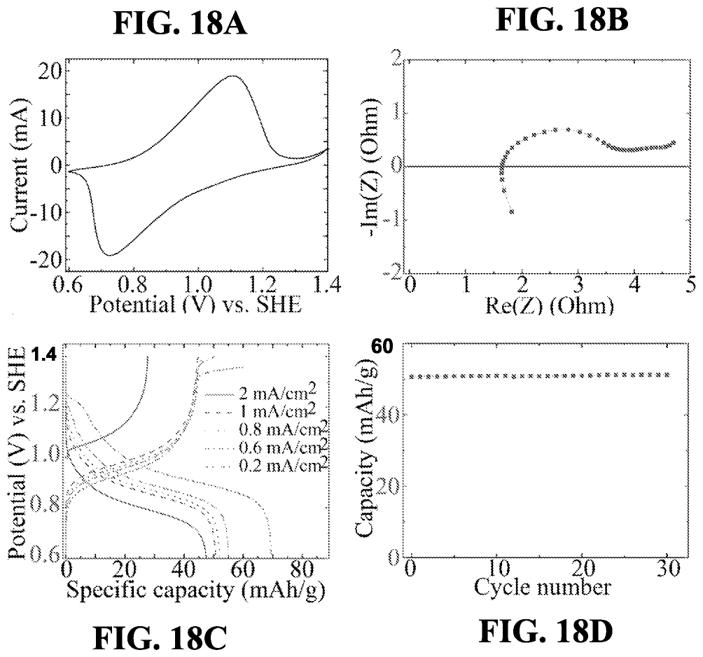

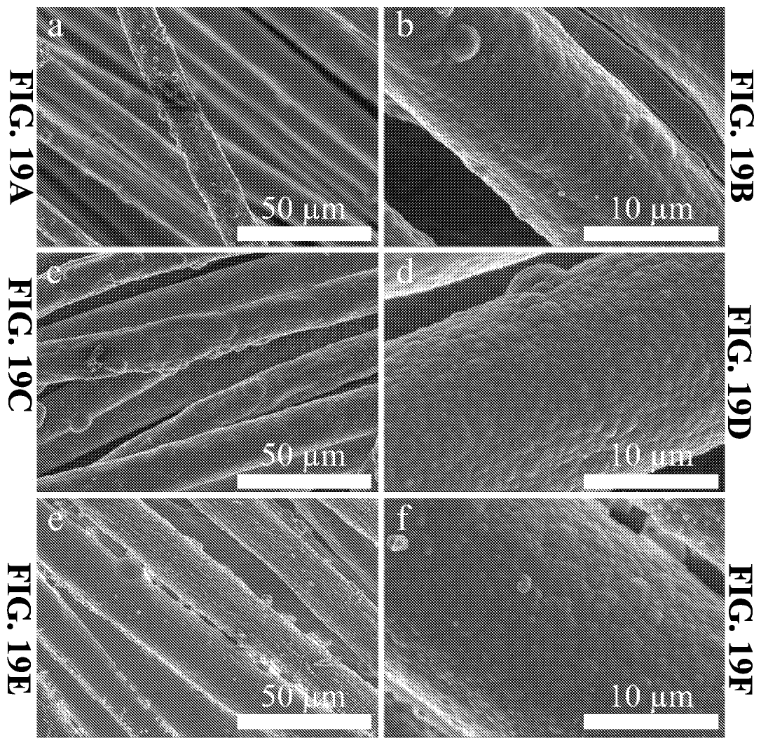

Lastly, FIGS. 18A-18D, the electrochemical properties were investigated as well. FIG. 18A shows that at a scanning rate of 10 mV/s, an oxidation peak at 1.1 V and a reduction peak at 0.7 V vs. SHE were observed, indicating a highly reversible redox reaction. FIG. 18B shows the impedance spectroscopy indicated a low ohmic resistance (1.6 ohm, intersection of the Nyquist plot with x-axis) and charge transfer resistance (2.0 ohm, diameter of the semicircle of the Nyquist plot). FIG. 18C shows that in the galvanic charge-discharge tests, the specific capacity of the electrode varied from 30 to 70 mAh/g at current densities of 0.2 to 2 mA/cm². FIG. 18D shows retained the capacity without notable loss over 30 cycles, when cycling 1 mA/cm², the CuHCF electrode.

By changing the deposition time, PPy electrodes can be obtained with different mass loadings without blocking the porous structure of the carbon cloth mesh. The resulting mass loadings were 4.3, 8.4, and 14.6 mg/cm² when the deposition time were 2, 4, and 6 hours, respectively. FIGS. 19A-19F provide SEM images showing a uniform coating wrapping the carbon cloth fibers. As the deposition time increases, the coating became thicker. FIGS. 19E and 19F shows no observable aggregation even for the 6 h samples. The samples with 4-hour deposition were used for the following characterizations.

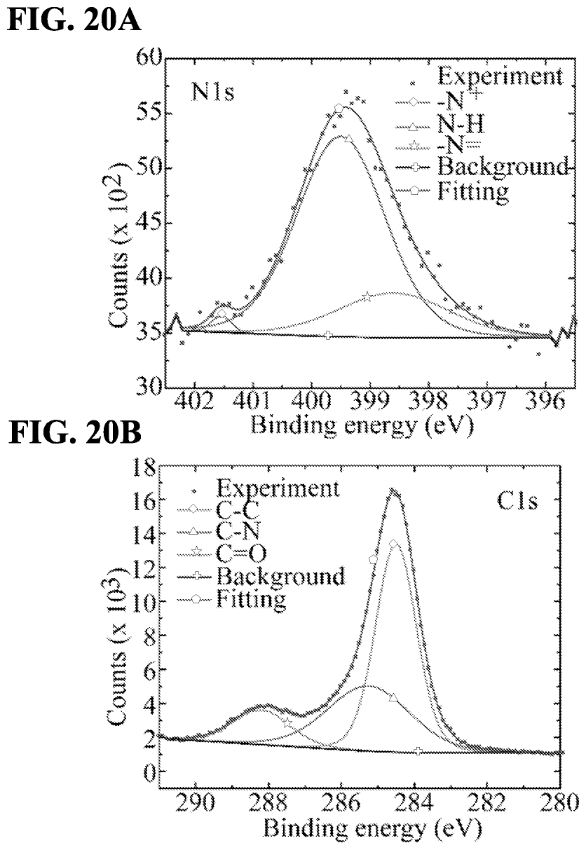

XPS was used to characterize the chemical state of the as-prepared PPy. FIG. 20 illustrates the presence of the N1s peak confirming the formation of PPy. The chemical state of PPy was characterized by deconvolution of the N1s narrow spectrum. The peak at 399.5 eV is the characteristic peak of amine nitrogen (N—H), the small peak at 401.5 eV represents the positively charged nitrogen (—N⁺), the wide peak at 398.5 eV was probably the imine nitrogen (—N═). Furthermore, as shown in FIG. 20, deconvolution of the C1s narrow spectrum resulted in three main peaks: C—C at 284.5 eV, C—N at 285.4 eV, and C═O at 288.4 eV. The result is consistent with the literature.

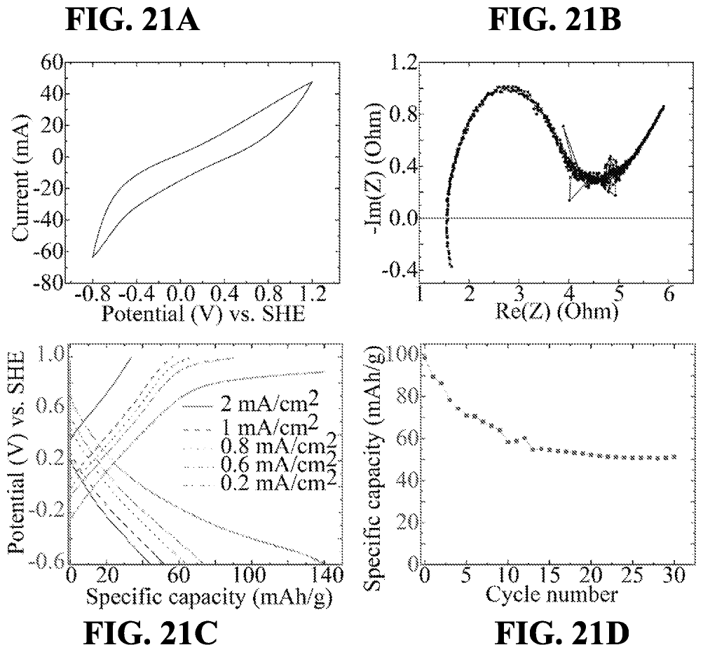

Electrochemical characterizations of the PPy electrodes in an embodiment of the disclosure were obtained from optimized fabrication. FIG. 21A shows the CV test of the obtained PPy electrode. FIG. 21B shows the impedance spectroscopy indicated a low ohmic resistance (1.5 ohm, intersection of the Nyquist plot with x-axis) and charge transfer resistance (2.7 ohm, diameter of the semicircle of the Nyquist plot). To investigate the capacity retaining ability of the PPy electrode, galvanostatic charge-discharge (GCD) curves were obtained by charging and discharging the electrode in a three-electrode set up at different current densities (0.2, 0.6, 0.8, 1, and 2 mA/cm²). FIG. 21C shows that at 1 mA/cm², 51.7 mAh/g specific capacity was retained, which is close to the 50.7 mAh/g of the CuHCF electrode at the same current density. FIG. 21D shows that over 30 cycles, the specific capacity of the PPy electrode decreased first and then became stable at around 50 mAh/g. The overpotential was around 0.1 V initially.

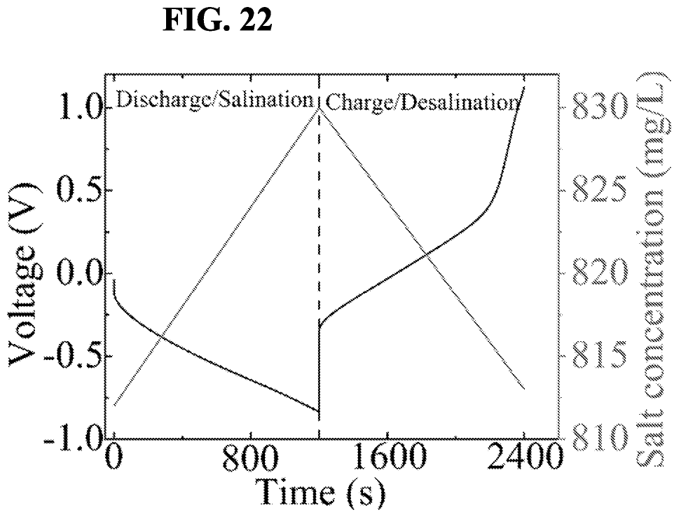

During a cycle of 20 min discharging and 20 min charging in the SEB cell, salination and desalination were observed in the stock water. FIG. 22 illustrates the NaCl concentration, of an exemplar embodiment, increasing from 812 mg/L to 830 mg/L during discharge, then dropping back to 813 mg/L after charging, which accounts for a salinity change of 18 mg/L. The cell achieved a coulombic efficiency of 50%, which was probably attributed to the suboptimal contact between the electrode materials causing high internal resistance. Further shown in FIG. 22, the overpotential was considerable across the cell. As the charge-and-discharge current was 5 mA, the energy consumption was calculated to be 4.14 J, which equaled 120 KJ/mole normalized to the moles of salt transferred.

To further demonstrate the cycling ability of the battery electrodes, charge-discharge cycles at 1 mA/cm² current density in a three-electrode setup was conducted. The electrolyte was 0.6 M NaCl, and the counter electrode is the same material but with much higher mass loading.

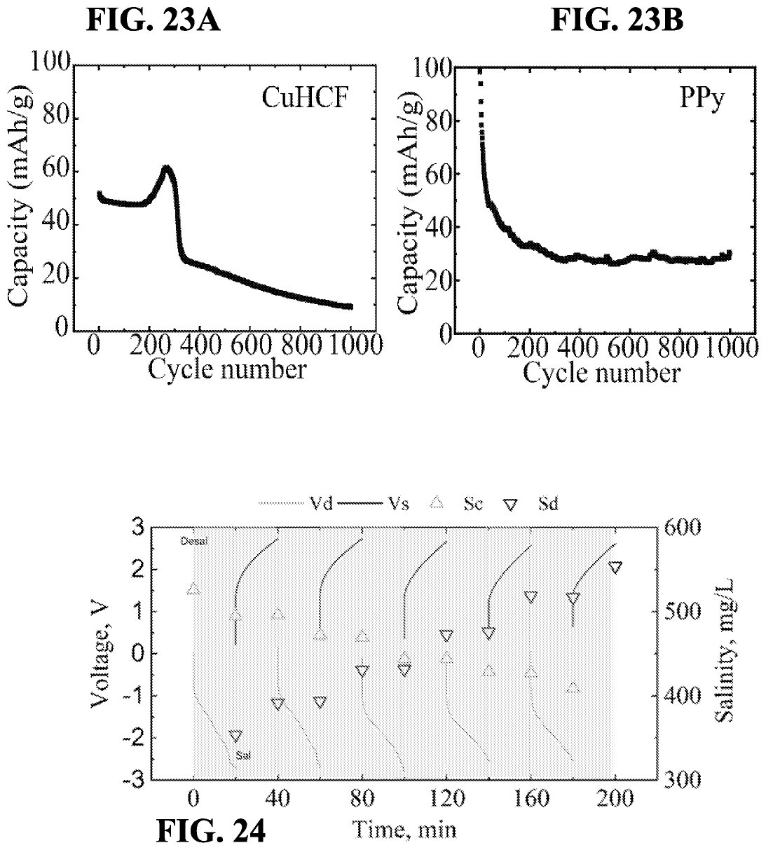

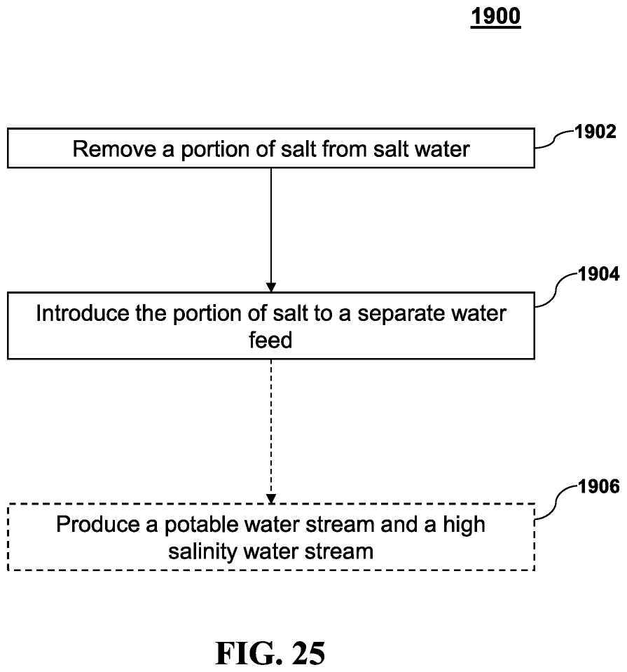

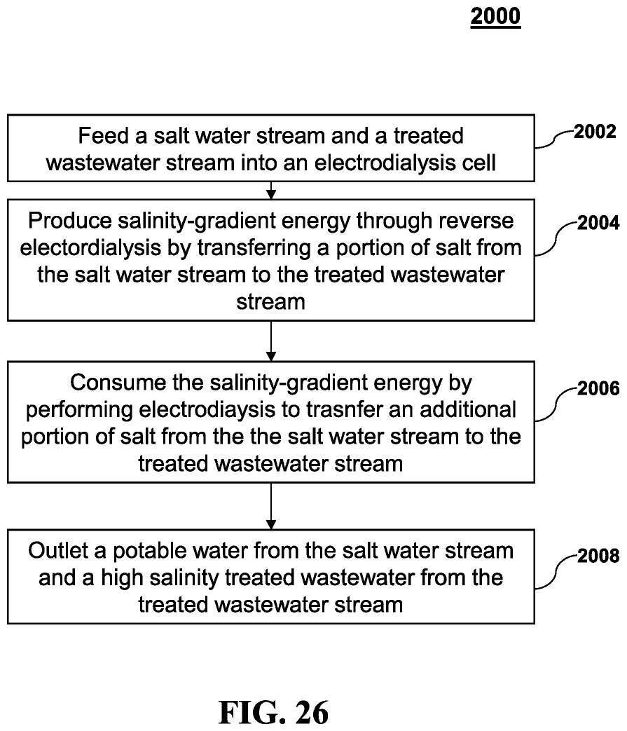

FIGS. 23A and 23B illustrate the results of the cycling in an embodiment of the disclosure. Over the first 200 cycles, the CuHCF capacity remained at around 50 mAh/g. After a peak, the capacity continuously decreased over the rest of the cycles to around 10 mAh/g, which is an underperformance compared to the reference (80% over 10000 cycles). The performance decline was probably due to the wash-off of the active material from the carbon cloth during mixing and charge and discharge. Yellowish precipitates, most likely oxidized Fe³⁺ ions from the CuHCF paste, were observed in the reactor. For the PPy electrode, the capacity stabilized at around 30 mAh/g after the initial 200 cycles. It has been reported that Prussian blue crystals like CuHCF are most stable at acidic pH (1-2), while the typical pH of seawater is 8.1. Therefore, the as-prepared CuHCF electrodes were far from stable when operated in alternating electrolytes like seawater without pH optimization. The current electrodes are not compatible with fast desalination and salination operation cycles, which further hinders the possibility of scaling up and commercialization of the battery system for salinity exchange between seawater and treated wastewater.

An exemplary embodiment of salinity exchange with SEB was demonstrated by switching the electrodes between two beakers with electrolytes of different salinity. An aliquot of 80 mL 526 ppm NaCl solution was first used as the concentrated electrolyte where electrodes were immersed in. The current density was 1 mA/cm². The desalination/charging process lasted for 20 mins. The salinity dropped to 495 ppm. Then the electrolyte was switched to 80 mL 354 ppm NaCl solution for another 20 mins to discharge the adsorbed salts into the relatively dilute solution to complete one cycle of salinity exchange. After the discharge, the salinity of the dilute influent increased to 392 ppm, indicating a higher coulombic efficiency for the discharge process. FIG. 24 shows the results of the exchange cycle through 5 repetitions, resulting in a 117 ppm salinity drop in the concentrated influent.

Over the five cycles, the total energy consumption was 120 J, which can be translated to 744 KJ/mol normalized to the moles of salt transferred. The energy consumption hiked up drastically for continuous salinity exchange cycles between two electrolytes (concentrated and dilute), compared to the 120 kJ/mol for a single cycle of salination-desalination in the same electrolyte. The typical energy consumption reported for desalination using capacitive deionization is around 100 KJ/mol salt. There could be two possible contributors to the higher energy consumption of the cycle test. One could be the beaker setup with a larger anode-cathode distance resulting in a much higher internal resistance of the system. A large portion of the generated energy during the desalination cycle was used to overcome the overpotential of the system. The other reason could be that the steep voltage increase during the desalination in the later cycles as the concentrated electrolyte being desalinated leads to much higher energy consumption. Therefore, compacted and stacked two-dimensional configuration could be necessary for scaled-up SEB cells of improved salinity exchange capacity. Still, the mass transfer and mixing of the electrolyte and the salt ions need to be optimized to limit the concentration polarization as well. Moreover, the high energy consumption of SEB for total desalination of saline water like seawater could remain to be the critical limiting factor moving forward to scaling up and commercialization.

In addition to the challenges mentioned above, the SEB system cannot prevent cross contamination between the two streams of influent given the operation procedures, considering the surface charge of some typical emerging contaminants like PPCP.

1. A method comprising:
introducing a first feed stream with an initial ion concentration of anions and cations to a cell;
introducing a second feed stream with an initial ion concentration of the anions and the cations to the cell, wherein the initial ion concentration of the first feed stream is higher than the initial ion concentration of the second feed stream;
transferring, through reverse electrodialysis, a portion of the anions and the cations from the first feed stream to the second feed stream;
extracting salinity-gradient energy from a difference in ion concentration between the first feed stream and the second feed stream; and
transferring, through electrodialysis, a portion of the anions and the cations from the first feed stream to the second feed stream.

2. The method of claim 1, wherein;
the first feed stream is a salt water feed stream; and
the second feed stream is a water feed stream.

3. The method of claim 2, wherein:
introducing the salt water feed stream to the cell comprises introducing the salt water feed stream to a feed chamber of a first set of adjacent chambers, wherein a salt water feed stream path through the cell includes a path portion through at least a second feed chamber of at least a second set of adjacent chambers;
introducing the water feed stream to the cell comprises introducing the water feed stream to a concentrate chamber of the first set of adjacent chambers, wherein a water feed stream path through the cell includes a path portion through at least a second concentrate chamber of at least the second set of adjacent chambers;
the feed chamber and the concentrate chamber are separated from each other in each set of adjacent chambers by an anion exchange membrane;
each set of adjacent chambers are separated from each other by a cation exchange membrane; and
the first and the at least second set of adjacent chambers are disposed between a pair of electrodes.

4.-7. (canceled)

8. The method of claim 1, wherein the transferring through electrodialysis comprises transferring through electrodialysis by consuming at least a portion of the salinity-gradient energy.

9. (canceled)

10. The method of claim 1 further comprising:
producing potable water from at least a portion of the second feed stream that exits the cell;
wherein the method consumes less than 1 kWh/m³ of potable water produced.

11. The method of claim 1 further comprising:
producing potable water from at least a portion of the second feed stream that exits the cell;
wherein the method consumes less than 0.5 kWh/m³ of potable water produced.

12. The method of claim 2, wherein the water feed stream comprises treated wastewater.

13. The method of claim 2 further comprising:
producing potable water from at least a portion of the water feed stream that exits the cell;
wherein the initial ion concentration of the salt water feed stream comprises a salt concentration ranging from about 0.1 M to about 0.6 M;
wherein the initial ion concentration of the water feed stream comprises a salt concentration ranging from about 0.01 M to about 0.03 M; and
wherein the potable water comprises a salt concentration less than 0.015 M.

14.-21. (canceled)

22. The method of claim 1, wherein:
introducing the first feed stream and introducing the second feed stream comprises feeding the first feed stream comprising salt water and the second feed stream comprising treated wastewater into alternating chambers of the cell, being an electrodialysis cell, wherein the alternating chambers of the salt water and the treated wastewater are separated by a set of ion exchange membranes;
transferring through reverse electrodialysis comprises transferring, through reverse electrodialysis, a first portion of salt from the salt water to the treated wastewater to approximately equalize a salt concentration in the salt water and a salt concentration in the treated wastewater;
extracting salinity-gradient energy comprises extracting salinity-gradient energy harvested from a difference in salt concentration between the salt water and the treated wastewater; and
transferring through electrodialysis comprises transferring, through electrodialysis by consuming at least a portion of the salinity-gradient energy, a second portion of salt in the salt water to the treated wastewater, to yield a desalinated salt water and an increased-salinity treated wastewater.

23. The method of claim 22, wherein the set of ion exchange membranes comprises an alternating set of anion exchange membranes and cation exchange membranes.

24. (canceled)

25. The method of claim 1, wherein:
the first feed stream is salt water;
the second feed stream is a wastewater;
transferring through reverse electrodialysis comprises transferring a first portion of salt from the salt water to the wastewater through reverse electrodialysis;
extracting salinity-gradient energy comprises extracting at least a portion of salinity-gradient energy harvested from a difference in salt concentration between the salt water and the wastewater;
transferring through electrodialysis comprises transferring a second portion of the salt, through electrodialysis by consuming at least a portion of the extracted salinity-gradient energy, from the salt water to the wastewater, to yield a decreased salinity salt water and an increased salinity wastewater; and
the method further comprises discharging the increased salinity wastewater directly to an environmental saltwater source.

26. The method of claim 25, wherein a salt concentration ratio between the salt water and the wastewater prior to reverse electrodialysis is greater than 1:1 and subsequent to reverse electrodialysis approximates 1:1.

27. The method of claim 25, wherein a salt concentration ratio between the salt water and the wastewater subsequent to reverse electrodialysis but prior to electrodialysis approximates 1:1 and subsequent to electrodialysis is less than 1:1.

28. The method of claim 1, wherein the cell is an electrodialysis cell comprising:
a set of adjacent chambers;
a set of ion-exchange membranes;
a pair of electrodes;
an electrode rinse solution;
a power source;
a saltwater feed stream inlet;
a treated wastewater feed stream inlet;
a decreased salinity saltwater stream outlet; and
an increased salinity treated wastewater stream outlet.

29. The method of claim 28, wherein:
the set of ion-exchange membranes comprises an alternating set of anion exchange membranes and cation exchange membranes;
the set of adjacent chambers alternatively connect:
the saltwater feed stream inlet to the decreased salinity saltwater stream outlet; and
the treated wastewater feed stream inlet to the increased salinity treated wastewater stream outlet;
the adjacent chambers are separated from each other by the set of ion-exchange membranes;
the set of adjacent chambers are disposed between the pair of electrodes; and
the pair of electrodes are in electrical communication with each other and the power source.

30.-33. (canceled)

34. The method of claim 28, wherein:
the first feed stream is a saltwater feed stream when introduced to the saltwater feed stream inlet;
the first feed stream is a decreased salinity saltwater stream when output from the decreased salinity saltwater stream outlet; and
the second feed stream is a treated wastewater feed stream when introduced to the treated wastewater feed stream inlet;
the second feed stream is an increased salinity treated wastewater stream when output from the increased salinity treated wastewater stream outlet; and
at least one of:
the system consumes less than 1 kWh/m³ of the decreased salinity saltwater stream;
the system consumes less than 0.5 kWh/m³ of the decreased salinity saltwater stream;
the saltwater feed stream comprises seawater;
the saltwater feed stream comprises brackish water;
the saltwater feed stream comprises a salt concentration ranging from about 0.1 M to about 0.6 M;
the treated wastewater feed stream comprises a salt concentration ranging from about 0.01 M to about 0.03 M;
the decreased salinity saltwater stream comprises a salt concentration less than 0.015 M;
the saltwater feed stream comprises a salinity ranging from about 9 g/L to about 32.45 g/L;
the treated wastewater feed stream comprises a salt concentration ranging from about 0.7 g/L to about 1.8 g/L;
the decreased salinity saltwater outlet stream comprises a salinity less than 0.9 g/L;
the saltwater feed stream comprises a conductivity from about 10 mS/cm to about 59.27 mS/cm;
the treated wastewater feed stream comprises a conductivity ranging from about 1.278 mS/cm to about 3.834 mS/cm; or
the decreased salinity saltwater outlet stream comprises a conductivity less than 1.917 mS/cm.

35.-46. (canceled)

47. The method of claim 28, wherein the pair of electrodes further comprises a conductor.

48. The method of claim 28, wherein the pair of electrodes further comprises a semi-conductor.

49. The method of claim 28, wherein the pair of electrodes further comprises a Ti mesh.

50. The method of claim 28, wherein the electrode rinse solution comprises a mixture of 0.05 M K₃Fe(CN)₆, 0.05 M K₄Fe(CN)₆·3H₂O, and 0.25 M NaCl.

51. The method of claim 28, wherein the increased salinity treated wastewater outlet stream meets a discharge standard for direct ocean discharges.
